(19) United States
(12) Patent Application Publication
(10) Pub. No.: US 2008/0204850 A1
(43) Pub. Date: Aug. 28, 2008

(54) Persistent Electro-Optic Devices and Processes for Optical Media

(76) Inventors: Anoop Agrawal, Tucson, AZ (US); John H. Rilum, Tustin, CA (US); John P. Cronin, Tucson, AZ (US); Juan Carlos Tonazzi Lopez, Tucson, AZ (US); Paul Atkinson, Poway, CA (US); Rick Marquardt, Clarcksummit, PA (US); Steve Parsons, Dover, NH (US)

Correspondence Address: WILLIAM J. KOLEGRAFF, 3119 TURNBERRY WAY, JAMUL, CA, 91935, US

(21) Appl. No.: 11/460,827

(22) Filed: Jul. 28, 2006

Related U.S. Application Data
(60) Provisional application No. 60/703,673, filed on Jul. 29, 2005.
(60) Provisional application No. 60/720,986, filed on Sep. 27, 2005.

(51) Int. Cl. G02F 1/153; G02F 1/15

(52) U.S. Cl. 359/273; 359/265

(57) ABSTRACT

An optical media is provided with an associated persistent electrochromic material. The electrochromic material has at least two states. In a first state, the electrochromic material interferes with the ability of an interrogating laser beam to read data from the optical media, and in a second state, the electrochromic material is substantially transparent, enabling the laser beam to read the disc. Advantageously, the persistent electrochromic material holds a desired optical state without the application of external power. The persistent time period may extend for days, weeks, or years depending on particular constructions, and on application requirements. The optical media has an integrated circuit, which is used to cause the electrochromic material to transition from a first state to the second state. In one example, an integrated circuit acts as the powering circuit for the electrochromic material, as well as providing logic and processing functions. The integrated circuit also couples to an RF antenna, enabling the integrated circuit to communicate with an associated RF scanning device.

### RELATED APPLICATIONS

This application claims priority to U.S. patent application No. 60/703,673, filed Jul. 29, 2005, and entitled “Devices for Optical Media”, and to U.S. patent application No. 60/720,986, filed Sep. 27, 2005, and entitled “Devices and Processes for Optical Media”, both of which are incorporated by reference as if set forth in their entirety. This application is also related to U.S. patent application Ser. No. ______, filed ______, and entitled, “Stable Electrochromic Device”, which is also incorporated by reference.

### FIELD OF THE INVENTION

The present invention relates to an integrated circuit device and electro-optical materials that cooperate to enable selective access to content stored on an optical media. In one example, the present invention provides a method and system for use of an optical device to reduce theft of optical media, deny or enable access to content stored within or on optical media, and for communicating an aspect of optical media via perceptible means.

### BACKGROUND OF THE INVENTION

An optical device, as the term is used herein, affects the ability of either man or machine to perceive or access some aspect of an optical medium. For example, an optical device may make media such as a compact disc (CD), digital versatile disc (DVD) or a high-definition disc (e.g., HD-DVD, Blu-ray Disc) readable or non-readable by blocking, reflecting, deflecting, polarizing, focusing, defocusing, changing the spatial or temporal phase magnitude, affecting the spectral response, inducing a wavelength change of, or otherwise disrupting or interfering with the interrogating light source. In a similar way an optical device may limit or control the recording access of an optical recording or rewritable medium such as a CD-R, CD-RW, DVD-R, or DVD-RW by affecting the recording light source.

Devices to affect the perceptibility of optical media are commonly implemented in configurations in which the device is separate and set apart from the optical media and rather a part of the readout or recording hardware. For instance, mechanical devices can be used to turn on or off the access of a playback or record beam to an optical medium. More elaborate devices can be employed to modify the interrogating optical readout beam in a playback or retrieval device to gain access to optical media with distinctly different resolution requirements (e.g. a CD/DVD switchable player).

It is, however, desirable from both business and hardware compatibility reasons to incorporate an optical device with the optical media as one entity and for the optical device to be switchable by electrical means, allowing for easy integration of logic components for controlling access and security of the optical medium. As detailed in U.S. patent Ser. No. 10/632,047, filed Jul. 31, 2003 and published as U.S. 2004/0022542, such an approach allows for implementation of, for instance, a secure movie rental scheme in which the underlying optical medium is a DVD. Another example detailed in U.S. patent Ser. No. 10/874,642, filed Jun. 23, 2004 and published as U.S. 2004/0257195, allows for denial-of-benefit security; a method of reducing theft of objects by effecting the utility of the object in a way that diminishes its value, and hence the incentive to steal it, until it is paid for and at which time its utility is restored. In some applications it is desirable and even required that the optical device can be switched from one state to another (e.g. non-readable to readable) only once. In other applications it is desirable or even required for that the optical device can be reversibly switched in a repeatable manner between at least two stable states, one state in which the optical medium is accessible and a second state in which the optical medium cannot be accessed. Furthermore, when the optical device and optical medium are properly designed, access to the content through the optical media should be equivalent or similar to that when no optical device is present, so that modification of the retrieval and/or recording hardware (e.g. the DVD player) is not required. For a given or selected format, such as that of DVD, the optical device-enhanced medium could then be compatible with a large installed base of retrieval or recording hardware.

Of particular interest are optical devices that are electrically activated using systems and methods described in U.S. patent application Ser. No. 10/874,642, filed Jun. 23, 2004 and published as U.S. 2004/0257195.

### SUMMARY

Briefly, the present invention provides an optical media with an associated persistent electrochromic material. The electrochromic material has at least two states. In a first state, the electrochromic material interferes with the ability of an interrogating laser beam to read data from the optical media, and in a second state, the electrochromic material is substantially transparent, enabling the laser beam to read the disc. Advantageously, the persistent electrochromic material holds a desired optical state without the application of external power. The persistent time period may extend for days, weeks, or years depending on particular constructions, and on application requirements. The optical media has an integrated circuit, which is used to cause the electrochromic material to transition from a first state to the second state. In one example, an integrated circuit acts as the powering circuit for the electrochromic material, as well as providing logic and processing functions. The integrated circuit also couples to an RF antenna, enabling the integrated circuit to communicate with an associated RF scanning device.

In one example, an electrochromic stack is constructed by positioning an electrochromic layer adjacent to an electrolyte layer. Electrodes typically attach to the layers for connection to a powering integrated circuit. The integrated circuiting also couples to an antenna for receiving power as well as data signals. When in a first optical state, for example a dark state, the electrolyte is in a highly stable state. Accordingly, there is almost no potential between the electrochomic layer and the electrolyte layer, so the electrochromic stack maintains the first optical state persistently. Upon the application of a voltage, the electrochromic layer (any possibly the electrolyte layer) transition to a second optical state, for example, a bleached state. The electrolyte layer also transitions from its first highly stable state to a second highly stable state. After the voltage is removed, there is almost no potential between the electrochomic layer and the electrolyte layer, because the electrolyte layer is in a highly stable state. Accordingly, the electrochromic stack maintains its second optical state persistently because the electrolyte layer is in a highly stable state

Advantageously, the persistent electrochromic device enables an optical shutter to be positioned on or in an optical disc, and for the shutter to maintain its bleached or colored state. In this way, a darkened shutter may disable access to the disc when the disc is manufactured, and then the disc moved through a distribution chain with confidence that the disc will remain unusable until an authorization event occurs. Upon the authorization event, for example, a consumer purchase, the optical shutter is transitioned to its clear state, and the clear state will be maintained, allowing the consumer to use the disc for years.

### BRIEF DESCRIPTION OF THE DRAWINGS

FIG. 1 is a schematic cross section of an optical disc in accordance with the present invention.

FIG. 2 is a block diagram of an EC device stack in accordance with the present invention.

FIG. 3 is a block diagram of an EC device stack in accordance with the present invention.

FIG. 4 is a block diagram of an EC device stack in accordance with the present invention.

FIG. 5 is a block diagram of an EC device stack in accordance with the present invention.

FIG. 6 is a block diagram of an EC device stack in accordance with the present invention.

FIG. 7 is a diagram of an optical disc with an EC device in accordance with the present invention.

FIG. 8 is an enlarged view of the EC device of FIG. 7.

FIG. 9 is a diagram of an optical disc with an EC device in accordance with the present invention.

FIG. 10 is diagram of masks for disposing an EC device in accordance with the present invention.

FIG. 11 is a diagram of an EC device layered in accordance with the present invention.

FIG. 12 is a graph showing % transmission versus wavelength for an EC material in accordance with the present invention.

FIG. 13 is a graph showing % transmission versus wavelength for ITO and IZO in accordance with the present invention.

FIG. 14 is a block diagram of an EC device stack in accordance with the present invention.

FIG. 15 is a diagram of an optical disc with an EC device in accordance with the present invention.

FIG. 16 is a graph showing transition timing for an EC device in accordance with the present invention.

FIG. 17 is a graph showing transition timing for an EC device in accordance with the present invention.

FIG. 18 is a graph showing transition timing for an EC device in accordance with the present invention.

FIG. 19 is a photograph of an EC Device in accordance with the present invention.

FIG. 20 is a graph showing error rate for a disc using an EC device in accordance with the present invention.

FIG. 21 has a set of shapes and densities for an EC device in accordance with the present invention.

FIG. 22 is a diagram showing edge effects for an EC device in accordance with the present invention.

FIG. 23 has a set of shapes and densities for an EC device in accordance with the present invention.

### DETAILED DESCRIPTION

Certain embodiments as disclosed herein provide for optical devices and optical devices configured in optical discs. After reading this description it will become apparent to one skilled in the art how to implement the invention in various alternative embodiments and alternative media. For instance, it can be appreciated that the teachings of the optical disc in the present invention may also be applied to other types of perceptual media such as an optical disc containing multiple information layers, a hologram, a holographic memory storage device, or printed material. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

### Optical Device:

An optical device may be constructed using thin films or gels or other materials typically layered or otherwise organized in ways that achieve their desired qualities such as rendering the perceptual (optical) medium accessible or non-accessible by blocking, unblocking, reflecting, polarizing, deflecting, focusing, defocusing, changing the spatial or temporal phase magnitude, affecting the spectral response, inducing a wavelength change of, or otherwise disrupting or interfering with the interrogating light source used for interrogating or recording in the optical media. Furthermore the optical device may e.g. be switchable in a repeatable manner between two stable states: an “open” accessible state and a non-accessible ‘off’ state. Additional intermediate states may also be conceived in which only part of the optical media can be accessed (e.g. defocusing or inducing spherical aberration in the interrogating light beam such that only one of some of the otherwise accessible layers of the optical medium can be accessed).

The optical devices of particular interest are those whose optical properties change in response to electrical signals and in particular electro-optic devices such as electrochromic (EC) devices. Examples of other electrically activated or switchable devices include: liquid crystals, polymer dispersed liquid crystals, dispersed particle systems, cholesteric liquid crystals, polymer stabilized cholesteric texture liquid crystals. Other examples of electro-optic devices which may also be employed use materials that show a change in refractive index (e.g., potassium dihydrogen phosphate (KDP), ferroelectric materials such as lead-lanthanum-zirconium titanate (PLZT), lithium titanate, barium titanate, polyvinylidene fluoride,) and those employing nanocrystal (or quantum dot) structures and particles where transitions are induced by electrical stimulation. Preferred optical devices have multilayer construction with at least two electrically conductive layers. Although the descriptions herein primarily use electro-chromic examples, it will be appreciated that other electro-optic materials may be used.

The materials used in the manufacture of the optical device may be produced or disposed using conventional film/material deposition processes ranging from sputtering, e-beam, and thermal evaporation to chemical vapor deposition or wet chemical deposition such as printing. In another example, one or more of the materials may be disposed using liquid ink-jet processes. These materials form an electro optical film or stack that may be assembled directly onto the optical media or an element thereof (e.g. a disc substrate) or a separate substrate, carrier, or tape for integration with the optical media. As discussed later, the electrically switchable optical device may also be combined with other optical layer or devices that switch from an exposure to stimuli other than electrical stimulus such as heat and radiation (including optical radiation).

### Optical Disc and Placement of Optical Device:

The method and means described herein are applicable to a variety of optical media and in particular a variety of optical disc configurations including, but not limited to single and dual or more layers, single and double sided, and symmetrical and asymmetrical configurations (e.g. single sided, single layer DVD-5s and dual layer DVD-9s, double sided DVD-10s and DVD-18s, compact discs (CDs) and the high-definition formats HD-DVD and Blu-ray Disc. The DVD substrates or any other optical media such as holographic media are made from clear plastic materials, for example, polycarbonate. Other materials such as acrylics (e.g., polymethylmethacrylate) and cyclic polyolefins may also be used.

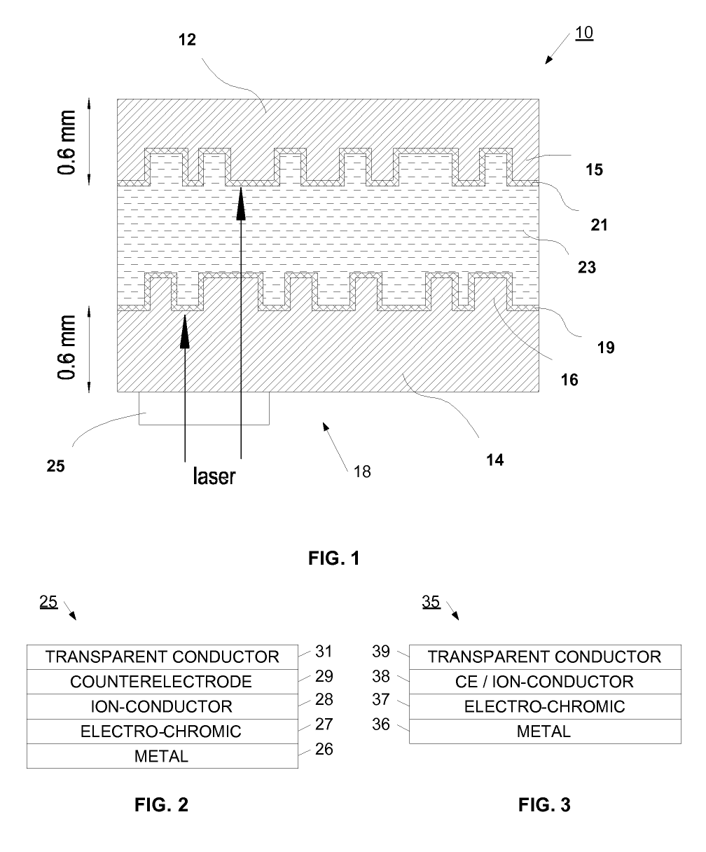

FIG. 1 shows a schematic cross-section of a DVD 10, known as a DVD-9, which has two substrates 12 and 14, typically made of transparent polycarbonate, each of which is about 0.6 mm thick and comprises a data layer (also known as data encoding or information layer) shown as 15 and 16. The disc is made by bonding two substrates (Substrate 1 (14) and Substrate 2 (12) with a ultra-violet (UV) curable bonding agent. The reading laser accesses the DVD from the readout side (18) as shown. Prior to bonding, Layer L0 (16) is coated with a semi-reflective material (e.g. a thin layer of gold or silver) (19) and Layer L1 (15) is coated with a reflective material (21) (e.g. a thin layer of aluminum). The reflectivities of L0 and L1 as well as the transmission of L0 are balanced to achieve comparable levels of overall reflectivity from each layer as seen by the interrogating laser beam from the readout side. By focusing the laser beam onto each layer the corresponding data layer can be accessed. Typically the thickness of the gold or silver applied to L0 is in the range of 5 to 20 nm and of aluminum applied to L1 in the range of 30 to 80 nm. The thickness of the bonding layer (23) is about 50 microns.

It is proposed that an electrooptic (EO) device (see 25 in FIG. 1), be located in or on the DVD so that such an EO device can be activated to effect changes in one or more of its optical properties and in particular to switch between colored or bleached states. These devices in the bleached state (or open state) would allow the laser beam access to the data layers and in the colored or dark (or blocking or closed) state would interfere with the transmission of the laser beam (e.g., by absorbing, reflecting, diffracting or combinations thereof) so that in at least one of the data layers the data area covered by this EO device is not readable. A preferred EO device is an electrochromic (EC) device.

As an example, the EC device would be colored for as long as the DVD or any other equivalent optical media, sits on the shelf of a retailer. When it is legitimately purchased by an end-user the retailer would effect an action whereby the EC device is altered or bleached thus allowing the content to be accessed (the disc made playable). This action, or “activation” is preferably conducted wirelessly, e.g., see U.S. Patent Publication 2004/0022542, which is incorporated herein by reference.

The EC device may be positioned such that it is between the interrogating laser and the data layers to which access is being enabled or denied. For example, the EC device may be positioned in the region between the two data layers (L0 and L1) where it would prevent the laser from reading data on L1. The EC device may also be located between L0 and the readout side of Substrate 1 to prevent both L0 and L1 from being read. In a single layer disc, the data layer can be located in substrate 2, e.g., data layer L1, and the EC device can be positioned similarly to that of a L1 in a DVD-9. There are also alternative multi-layer disc configurations and methods of bonding, in which L0 is placed on a third, very thin substrate (substrate 3) which is bonded to substrate 2 (on top of L1), and upon which Substrate 1 is subsequently bonded. In such a configuration, the EC device could be located in-between L0 and the readout side (e.g. on top of L0).

In particular constructions of the optical disc, one or more metal layers within the body of an optical disc (as shown by gold and aluminum layers, L0 and L1 respectively) are used as elements (electrodes) of the EC device. Also disclosed are examples of an EC device located relative to the metalized data layer or layers in an optical medium. Example EC devices may also be formed on a substrate which may then be integrated with the DVD. The substrate with the EC device may also have electronic components and antennas integrated on to either side of the substrate. This substrate may be integrated within the DVD, e.g., between the two halves of DVD-9, DVD-10, DVD-18, HD-DVD etc. or on the surface of the air-incident side of a finished DVD so that it is able to interrupt the reading laser beam when desired. In the later example, the substrate may be bonded to the disc using for example, a UV curable adhesive. The entire surface of the disc, including the bonded substrate may then be coated with a hard, scratch-resistant coating (e.g. UV lacquer). Also disclosed are attributes of the EC devices which are suitable for this purpose. Further disclosure is given of methods and processes to form and integrate these devices on the optical media. In some constructions devices are discussed having mixed or multiple functionality where more than one mechanism is used to change the state of the optical devices.

In cases where the optical device uses a separate substrate, the substrate may be flexible or rigid and may or may not include an adhesive, such as a PSA (pressure sensitive adhesive) material or other material to assist in the process of bonding the optical device to the disc. One or more EC devices, with electronic components and antennas as appropriate, may be assembled on a single item of substrate. For example, EC devices may be assembled along a continuous reel of flexible substrate in a continuous web process or in rows and columns on large sheets of rigid substrate, such as ultrathin glass or a thermoplastic or a thermoset plastic. The electronic components may be positioned using pick-and-place manufacturing processes and the antennas may be screened, printed, ink-jetted or deposited to the substrate. The fully constructed substrate, including electronic components and antenna as appropriate, may be stored as assembled on continuous reels or sheets or cut into individual units.

Individual substrates may be placed in the appropriate position relative to the disc using mechanical means (e.g. a pick-and-place machine). Substrates on continuous reels may be rolled directly onto the medium if e.g. using an adhesive substrate. Alternatively the disc can be furnished with a curable polymer/lacquer (e.g. hot melt of UV curable) or optical quality cement before the optical shutter assembly is applied. To maintain an overall thickness consistent with the appropriate specifications (E.g. DVD, HD-DVD or Blu-ray) and industry norms, and to insure compatibility with reading devices and players, the disc may be manufactured (e.g. molded) slightly thinner to accommodate the additional thickness of the EC device and its substrate and surface coating if appropriate.

Some of the substrates to form these devices are made of polycarbonate, polyester (e.g., polyethyleneterephthalate and polyethylenenaphthalate) polycycloolefins and acrylic (e.g., polymethylmethacrylate) polymers in a thickness of less than 0.3 mm (preferably In the 20 to 150 micron range), and ultrathin glass in a thickness of less than 200 μm (preferably 20 to 60 micron range). A preferred polycarbonate product is an extruded film called Europlex® PC from Degussa, Germany, of which a specific example is grade 0F405. Ultrathin glasses for example are available from Corning (Corning, N.Y.) as Microsheet Glass and from Schott Glass (Mainz, Germany) as D263T and AF45 glasses. If the external integration method is used, the substrate surface area and shape may be as big as the DVD, or it may be smaller. A disc shaped substrate may also have protruding areas from the perimeter where the device may be located. The optical disc (e.g. DVD or HD DVD) may also be molded with indentations on their external surfaces shaped similarly to the substrate and any components mounted to it, to allow the substrate to be housed and bonded seamlessly in this indentation and thus maintain the disc's original form. For external integration using polymeric films one may pre-coat these with a hard coating, or a hard coating may be deposited after the film is integrated with the disc. The hard coats such as silica, silica and aluminum nitrides may be deposited using physical or chemical vapor deposition, or hard coats may be deposited by a wet-chemical deposition. One preferred method is by spin coating after the film is bonded to the disc.

An alternative is to form, dispose, or assemble the electro-optic device and other components on the disc itself. Yet another alternative may be to form, dispose, or assemble some of the components on the disc (e.g., EO device and the chip) while the other components (e.g., antenna) are assembled on a different substrate and then connected to the components on the disc. In the latter case the antenna may be removed by the end-user before playing the disk. The removable antenna may be affixed to printed lines on the surface of the disk using “Z axis conductive” adhesive. A Z axis conductive tape has conductive paths that allow antenna signals to be passed through the conductive tape, while avoiding shorts between paths. In this way, an antenna may be adhered to a set of antenna contacts on the disc, with the tape providing sufficient electrical connections between the contacts and the antenna. These are anisotropic conductors which only conduct in their thickness direction and are typically sold as tapes which are thermosets or thermoplastics (including pressure sensitive tapes). As examples these are available from Btech Corporation (Longmont, Colo.) as ACF film and 3M Corp (Saint Paul, Minn.) as tape 9703. An example construction for a dual layer disc has the EC device positioned between these two metal layers and configured such that one of these metal layers (e.g. either L0 or L1) is used as an electrode in the EC device. For those DVDs which have only one data layer (e.g., a DVD-5), the metal layer may also be used as an electrode for the EC device. For those DVDs where more than two data layers are used (e.g., a double-sided, dual layer DVD-18) the EC device may use any of the metal layers as electrodes. To achieve desired switching times, a preferred surface resistance of the electrode layer is less than 100 ohms/square. As an example the surface resistivity at about room temperature for a 20 nm thick gold electrode is about 1.1 ohms/square and that of 40 nm aluminum would be about 0.66 ohms/square.

### Electrical and Optical Characteristics of the EO Device

Several descriptions of the EC devices will be given below which may be used for this purpose. More specific placement configuration and geometry of the devices on DVDs will be discussed later. Of particular interest are EC devices that do not require any external power to maintain either their colored or their bleached states. In this way, the EC device persistently maintains the desired state. In some cases, the desired state may be a persistent bleached state, and in other cases, a persistent colored state may be desired. The length of the persistent state may be defined according to application needs. As an example, the colored state (i.e. time lapsed between DVD production and sold to end customer) should be as long as possible, and the most preferred state is forever, or at least for a commercially required period of time. However, a minimum period for which this layer should remain dark to prevent a DVD being operated is greater than three months and a more preferred time period is greater than 3 years. Similarly, once the DVD has been purchased the EC device should not become dark or closed with time as this DVD will become unusable and expire. For certain applications such as rentals, only a short expiration period is required for the content to be accessible, whereas for others such as a purchase, longer expiration periods (or no expiration) are preferred. Thus the bleach period (open period or time to expire) required for rental applications may be only a few (e.g., four) hours to a few days (e.g. 2 days), whereas for end user who purchase a DVD this period would be greater to e.g. 2 years or preferably longer (e.g. 10 years or more). In certain situations, e.g. in rental business, it may be desirable for an expired DVD to be made operable again by bleaching the EC device (e.g. at the rental agency). In another model for the rental agency, the disk expires permanently so that the consumer may discard the DVD after the expiration period rather than return this back.

Limited duration use optical media has been discussed in several publications such as U.S. Pat. Nos. 5,815,484, 6,011,772 and in 6,917,579 where a reactive layer is inserted before the reading optical beam (e.g., a laser) accesses the data layer. The optical properties of this reactive layer change upon a triggering event (such as removal of a label or a package, exposure to light, etc.) or simply change with time, particularly as this layer comes in contact with diffusing moisture and or oxygen. The information in these patents pertaining to processing, materials used, positioning of materials used, etc., is all included herein by reference. In all these cases the optical media goes from being in an open state (meaning where data can be accessed) to a closed state (where data cannot be accessed) as the optical properties of the reactive layer or the active optical layer change. We disclose a novel concept where the reactive layer or the optically active layer is in the closed state, and it is opened for a limited time to allow access to the data and then back to a closed state. Alternatively, the open state of the device may also be configured so that it remains open indefinitely (or as long as required for the application) after it is activated.

For the purchase model, EC devices described below are highly desirable. In such a purchase model, EC devices are preferred that result in one way switch. In this way, the target optical disc may be made unreadable at the time of manufacture, remain unreadable as it progresses through the distribution chain, and then be switched to a persistent readable state at the time of authorized sale. Typically this is done by combining an EC state chance with a non reversible reaction in the device. The non-reversible reaction may support or effect the state change in the EC material, and may be a chemical reaction activated responsive to electrical stimulation. This chemical reaction may result, for example, in persistent polymerization or depolymerization, or in an irreversible chemical oxidation or reduction. Examples of these will be provided later. Particularly desirable are those EC devices which do not exhibit any meaningful potential between the electrodes, either in the colored or bleached state but only change the state when activated by an appropriate voltage. Such devices can be stored in their desired states for a long time without undesirable self discharge through the ion conductor or an external circuit to which they are connected to. EC devices known in the art have a substantial potential between the two electrodes in at least one of the optical states. An EC device is typically controlled or driven by an external circuit that applies an electrical charge when a state change is desired. Depending on circuit design, when the circuit is no actively driving the EC material, the external circuit may present an impedance between the two electrodes from a short to about 20 Mohms. When sufficient potential exists between electrodes, the driving circuit will allow current to drain between electrodes, thereby allowing the EC material to transition from its desired state. Also if diodes (including surface diodes) are used in external circuits then these diodes may be turned on by residual potential in an EC device. If these diodes are turned on, then current will flow, allowing the EC material to transition from its desired state. A typical voltage range to turn on the diodes are between 0.2 to 1V. To avoid activating the diodes, an EC device should have a residual voltage in any of its optical states (usable optical range for a particular application) to be less than 0.2V and preferably close to 0 volts. A use of such device is discussed below for optical media but these EC devices may also be used for tamper resistant labels for a variety of products, displaying product status as it moves down the manufacturing to retail chain, displays, greeting cards, credit cards, and the like. In some cases, unauthorized individuals may attempt to change the EC material to its “on” state through tampering in an effort to illegally gain access to the disc's content. For example, they may subject the disc to temperature extremes, to humidly, to chemicals, to shock, or to other stimulation. Therefore, it is desired that the EC device remain stable even at elevated temperature, humidity or when subjected to radiation (e.g., microwave, UV, solar radiation, etc.), or common chemicals so that the tampering with the EC device will not result in unauthorized access. In cases where extreme tampering may result in an unauthorized state change, it may be desirable to permanently disable a disc when the disc is tampered with by subjecting it to excessive temperature, chemical exposure, or radiation. More generally, the EC device should remain stable under normal usage conditions, which may include exposure to temperate extremes, for example. Depending on the product and the expected usage, these conditions could be defined. For many consumer products typical high temperatures in excess of 60 or 85 C for more than 1 to 10 hours would be very unlikely under normal consumer abuse, and would tend to indicate intentional tampering. In one example, optical stability for EC devices may be demonstrated by 1) measuring voltage across the EC device conductors, or 2) shorting the conductors and measuring how long it takes for the EC device to transition away from the desired state. These measurements may be taken in typical use conditions, which may include expected temperature or environmental extremes. For example, the voltage may be measured and the conductors shorted at room temperature, and up to 80 C. It will be understood that other temperatures and conditions may be used depending on the application.

Known EC devices generally require external power to keep at least one of its completely bleached or completely colored states for prolonged periods. Otherwise, they relax or transition to one of the optical states, called rest state. In one of the configurations of the EC device, the device keeps its completely colored state until activated, without any power consumption for several years or preferably forever. It will be appreciated that it may be acceptable to persistently hold the colored state for a time period defined by commercial requirements, which may vary depending on the specific application. Once the change is triggered this device should go to its bleached (or open) state and forever allow access to the data on the disc. It will be understood that the length of time the EC device needs to remain persistently colored, and the time the EC device needs to be persistently bleached, will vary depending on the specific application. For example, it may be acceptable for a particular DVD title to be persistently colored for only the first 6 months after manufacture, because the bulk of sales will be within the first few months. In a similar manner, it may be acceptable that the EC device, after authorized change to the bleached state, may be persistently held in the bleached state for only 3 years, since the content will be out of date or undesirable after that time period. It will be appreciated other time periods may be selected.

In another configuration if the content of the media, e.g., DVD is rented for a short while, then the device should go to its open state when triggered legitimately and then return to dark state (or close) within a few hours or days (as desired by the application) so that the data again becomes inaccessible. The limited open time EC device can be designed using EC technologies explained below. As in a battery, a limited-time reversible EC device will typically have a potential between the two electrodes when it is completely colored or completely bleached or in both extreme states. When this potential exists in the colored state, it will drive an internal reaction where most of the color may be gradually lost over a period of time. One way to arrest this is to reduce or eliminate this potential by choosing an EC material which in its colored state has the same potential as the counterelectrode or is at its natural rest state (this means 0 potential between the two electrodes). For those EC devices that have potential in one of the states (e.g., bleached state) the device will gradually gravitate towards the colored state making the disk non-playable at a threshold optical transmission value. Also, one may reduce the electronic leakage between the two electrodes to keep the coloration level for long/or desired amount of time. Electronic leakage through the device can be controlled by the properties of ion conductor. EC devices may be made with a leakage current of 10 μA/cm2 to less than 1 nA/cm2 to give a limited open time. The area refers to the area of the EC device. In this way, adjusting the material composition to affect the leakages current enables construction of discs that stay in a state for a predictable time period. It will be appreciated that the time period may vary depending on conditions, and that the time period is in part dependant on the characteristics of the device attempting to read the disc. For example, an EC device fading from its fully darkened state to a more transparent resting state may by be readable in one disc player before it is playable in a different disc player. In a similar way, an EC device fading from its fully bleached state to a more opaque resting state may by be readable in one disc player longer than in a different disc player.

Transparency of the device should be in any optical region of interest for a specific product, and at present, for DVDs the wavelengths of interest are at about 650 nm, for high-definition (high density) discs at about 405 nm, and for conventional compact discs (CDs) at about 780 nm. It will be understood that other wavelengths may be desirable depending on application specific requirements.

### Electrochromic (EC) Materials Devices and Their Processing

There are several types of known EC materials which may be used for providing selectable optical states. A description of various standard EC materials is given in U.S. Pat. No. 6,493,128. However, these EC materials as constructed using known processes, need on-going power to maintain a desired state, or else they transition to an undesirable rest stated. As described below, EC materials are selected to interact with another material in an EC stack, and when the EC material is in its desired long-term state, the other material is in a highly stable condition. In this way, there is almost no voltage across the EC device, so almost no leakage current is generated. Therefore, the EC material remains in its desired state persistently.

FIG. 1 shows a DVD 10 construction with dual layers. The two substrates 12 and 14 are formed separately with molded in data pits. The substrates and data pits are coated with metal layers 19 and 21 and then bonded. The EC device 25 may be located between the two substrates as described below. An EC device may be constructed where the two metal layers on the DVD are used as electrodes. Depending on the type of EC device, the metal layers may be further coated with EC and counterelectrode materials. The bonding material may be replaced by an electrolyte or ion conductor. In another design, only one of these metal layers is used as an electrode and a thin film stack comprising another conductive layer may be deposited to make a complete EC device. Example EC devices may use a film stack approach using only one of the metal layers so that it can be formed on one of the disc halves without complicating the assembly and alignment of the two halves. When the EC device is sandwiched between two conductive electrodes, and uses one of the above described metal layer as an electrode, it is desirable that the second conductive electrode in the stack be a transparent conductor (TC). The layers of the device excluding metallic layers (such as L0 and L1) should be highly transparent in the open state and induce least distortion to the optical passage of the interrogating optical beam.

FIG. 2 shows an example construction of a thin film device 25 that uses a metal layer 26 of the disc as an electrode and with subsequently deposited layers of EC material 27, ion conductor 28 and counterelectrode 29, and an opposing transparent conductive electrode 31. The metal layer 26 may be the same as one of the metal reflective data layers L0 and L1 as shown in FIG. 1. The device in FIG. 2 may also be fabricated by inverting the layer sequence, where instead of EC layer, the counterelectrode 29 is deposited on the metal 26, followed by the ion-conductor 28 and then the EC layer 27.

Metal layer 26 may be made out of any metal or a reflective layer which is optically useful for the DVD technology, and as long as it is conductive and electrochemically compatible it could be used as an electrode for EC. Other preferred metals are aluminum alloys (including aluminum/titanium alloys), silver and its alloys, rhodium, titanium, nickel, chromium, antimony and its alloys, tantalum and stainless steel. Of these, preferred aluminum alloys are 2000 series (with mainly copper), 5000 series (with mainly magnesium), 6000 series (with mainly magnesium-silicide) and 7000 series (with mainly zinc). The percentage of the alloyed materials is generally in the range of 0.5 to 3 atomic percent. In aluminum/titanium alloys, the percentage of Titanium is in the range of about 0.5 to 50%. There may also be other added alloying elements in lesser quantities such as chromium, lithium, manganese, titanium, zirconium, iron, lead and bismuth. The preferred alloys of silver are with one or more of neodymium, palladium, gold and platinum. The alloying elements in silver are usually added in a range of less than 3 atomic percent. The preferred stainless steels are 316, 304 and 430.

The conductive electrode layer may not be a single reflective layer but rather it may be composed of several metal layers or a combination of metal and transparent conductor layers. Use of multiple layers avoid the corrosion and electrochemical activity issues of the underlying layers while still being able to use their electrical conductive characteristics. A multilayer conductive electrode may be comprised of a transparent conductor (TC) deposited over a metal layer. Examples of preferred transparent conductors are doped tin oxide, doped indium oxide and doped zinc oxide. Tin oxide may be doped with antimony or fluorine, indium is usually doped with tin oxide (Indium—Tin Oxide (ITO)) or with zinc oxide (called IZO) and zinc oxide is usually doped with aluminum oxide. In ITO and IZO, the atomic percent of tin and zinc is rather high, in the range of 5 to 20% for tin, in the range of 15-50% for zinc, whereas in the other cases the dopant concentration is usually less than 5%. The resistivity of these layers should be as small as possible and for optical media applications less than 100 ohms/square is acceptable. Typically these resistances can be achieved in coatings with a thickness of 50 nm or more, where a range of about 50 to 200 nm is preferred. Organic conducting layers may also be used which may be formed using conductive polymers, carbon nanotubes and polyhedrals. The thickness of the metal layers is typically less than 50 nm and that of the TC deposited on the metal is less than 200 nm, preferably less than 100 nm. Multiple metallic layers are used where one of the metal layers serves as adhesion promotion layer between the plastic substrate and the next metal. Some of the adhesion promotion metal layers are chromium and titanium in a thickness of about 5-20 nm. For the purposes of illustrating the EC concepts clearly, we will assume that all the EC devices are built after depositing a gold layer on one of the polycarbonate disc substrates (either L0 or L1) and that it will be used as one of the conducting EC electrodes. The device concepts here can be adopted for depositing them directly onto the Data layers, or on separate substrates which are then integrated with the DVD. For those devices which are formed separately and then integrated, it is preferred that both of the electronically conducting layers of the EC device are transparent. Further if this substrate is placed between the two DVD halves, then it is preferred if the refractive index of this is matched to that of the UV curing glue used to assemble the two halves to within 0.2 and preferably within 0.02 units.

In FIG. 2, the EC layer 27 may be an inorganic oxide or a polymeric material. Some of the preferred inorganic oxides comprise of tungsten oxide, niobium oxide, prussian blue, molybdenum oxide, nickel oxide, and iridium oxide and some of the preferred organic polymers are polyaniline, polypyrrole, polyethylenedioxythiophene (PEDOT), polyisothianaphthene and their derivatives. These materials may be amorphous or crystalline. Alternatively, the EC layer may be metallic, for example, aluminum, nickel, or other metal. The ITO (TC) coating may also be used on top of the metal layer as an EC electrode. The thickness of the EC electrode is usually in the range of 100 to 500 nm. These layers may be reduced by injecting them with protons, lithium, sodium, potassium and silver ions along with electrons. The EC layers may also be oxidized by removing these ions and electrons. Tungsten oxide, niobium oxide, molybdenum oxide, polyisothianaphthene and PEDOT color upon reduction whereas others e.g. polyaniline, nickel oxide and iridium oxide color by oxidation. As discussed later one may use both types of EC layers in a device by combining complimentary EC materials i.e., the ones that color upon reduction and those that color upon oxidation. When the device is bleached, both layers bleach and when it is colored then both of the layers color. Organic EC layers may also be formed by taking the organic ion conductors described below and co-reacting or physically trapping organic EC and/or redox materials, such as viologens, amines, ferrocenes, ferrocenium salts, etc.

The ion conductors 28 in FIG. 2 are configured according to the ions which are transported through the electrolyte medium. For example, tantalum oxide is a good proton conductor and lithium niobate, lithium tantalate, lithium silicate, lithium aluminum fluoride and lithium-phosphorous oxynitride (LIPON) are good lithium ion conductors. Sodium β alumina is a good sodium conductor and rubidium silver iodide and silver β alumina are good silver ion conductors. Polystyrene sulfonic acid or other polymeric acid salts of sodium, lithium and potassium are able to conduct either of protons, lithium, sodium and potassium respectively. Some examples are sodium and lithium salts of polystyrene sulfonic acid, polyacrylic acid, polyacrylic and maleic acid copolymers, poly 2-acrylamido-2-methylpropane sulfonic acid (polyamps), etc. Other polymers with sulfonic acid, carboxylic acid moeities may also be used. The above polymers with acid groups (i.e., without the salt formation) may also be used as proton conductors. The conductors may be cation or anion conductors. The thickness of the ion-conductors is about 10 to 5000 nm. Polymeric ion conductors may also be made by adding salts, ionic liquids and plasticers that solubilize salts to any crosslinking or non-crosslinking polymers as long as these are compatible. Compatibility can be easily gauged by transparency of the system, as non-compatible systems will phase separate to a point that they will be opaque or translucent. Such ion conductors may comprise of polyether and polyamine moieties. Preferred polyethers are polyethylene oxide and polypropylene oxide. End functionalized polyethers could be employed to generate crosslinked networks of ion conducting materials. Depending on the functionality coreactants may be required. For example Vinyl, acrylic and methacrylic end functionalities are typically used for curing by UV and thermal processes. One may use coreactants to form urethane, siloxane, epoxy, polyester or nylon bonds. As an example, if the functional groups are polyols one may use isocyanates for forming urethane networks. These will also comprise of appropriate initiators and/or catalysts along with adhesion promoters, oxygen scavengers, additional crosslinkers, etc. These EC devices may also function by the movement of anions rather than cations. Thus the ion conductors may be anionic, such as polymeric quaternary ammonium salts with mobile anions such as trifluoromethylsulfonate (“triflate,” CF3SO3-), bis(trifluoromethylsulfonyl)imide (N(CF3SO2)2-), perchlorate ClO4-, bis(perfluoroethylsulfonyl)imide ((C2F5SO2)2N—)), tris(trifluoromethylsulfonyl)methide ((CF3SO2)3C—)), tetrafluoroborate (BF4-), hexafluorophosphate (PF6-), hexafluoroantimonate (SbF6-), and hexafluoroarsenate (AsF6-).

The counterelectrodes 29 may be complimentary to the EC electrodes in terms of optical coloration or may show a little or no optical change upon oxidation and reduction. In conventional EC devices the purpose of the counterelectrodes is to store ions which are injected into or ejected from the EC layer when a voltage is applied across the electrodes 26 and 31. These electrodes are also known as ion-storage electrodes. As an example in an EC device that uses an EC layer that colors upon reduction one may use the counterelectrode as another EC layer that colors upon oxidation. Thus when the ions leave the counterelectrode this layer oxidizes (and hence colors) whereas the EC layer also colors as the ions enter this layer and it reduces. Examples of inorganic counterelectrode (CE) materials that do not change their color upon oxidation and reduction are, e.g., are titanium vanadium oxide and cerium titanium oxide. Generally the thickness of counterelectrodes is in the range of 100 to 500 nm. Each of the layers in the EC device may be a single layer of one material or a composite of multiple materials, or they may comprise of multiple layers of different materials. The counterelectrodes may also be organic and their nature oxidizing or reducing is typically opposite to that of the EC electrode. For example a device using an EC electrode of polyaniline which bleaches from a colored state to a bleached state by reduction, would have a counterelectrode which can oxidize. Some of the organic materials for this purpose may be phenazine and hydroquinone and their derivatives. These materials may be incorporated in a solid device by tying them covalently to a polymeric backbone and/or incorporating them in a thermoplastic or a thermosetting matrix. Preferred matrices are polymers which are described in the ionic conductors above. This may be done to increase the ionic conductivity of the layer for faster switching devices. For example CE materials may be made, e.g., hydroquinones mixed with ion conducting polymers as given above, and vanadium or nickel oxide in Li—Al fluoride. Some examples of EC materials made by combining ion conductors and EC materials are polyaniline with polyamps, polymeric quaternary ammonium salts or with sodium salt of polystyrene sodium sulfonate, polyacrilic acid and Nafion®, etc. Another example would be tungsten oxide and molybdenum oxide mixed in Li—Al fluoride.

The mobile ions, e.g., protons, lithium, sodium or silver are introduced in the device by co-depositing these with the EC or the counterelectrode (CE), or as a separate layer which is then intercalated into the EC or the counterelectrode, or by chemical or electrochemical reduction. The various layers in the EC device may be deposited by physical vapor deposition (PVD), chemical vapor deposition (CVD) or by wet chemical processing (spinning, dipping, spraying, ink jet printing including patterning of solutions). PVD includes reactive sputtering of metals, radio-frequency or pulsed DC sputtering of non-conductors (e.g., oxides), thermal, laser and e-beam evaporation. These processes may also be assisted by plasma and ion treatments. Lithium is difficult to co-deposit by sputtering or evaporation of lithium metal due to its high reactivity. A preferred method is to use an alloy of lithium and aluminum for evaporation or sputtering. This results in a preferential removal of lithium from the target, and oxygen in the processing chamber is bound by aluminum. In another alternative tungsten oxide comprising oxide materials may be deposited by sputtering in an argon atmosphere which leads to films in the reduced (or colored) state.

Irreversibility or limited cyclability may be introduced to the point of only allowing the device to change once before it locks in the change permanently by several means. One may use a counterelectrode which does not result in reversible change, e.g., zinc oxide, tin oxide, silica, alumina, etc., when intercalated with protons or lithium or causing irreversible chemical/electrochemical changes. The intercalated ions may be made irreversible with time as they bind or react slowly within the host layer. Since these materials are not known to intercalate these ions, such ions may nevertheless be inserted by applying high voltages, i.e. in excess of 2V and preferably in excess of 2.5V and most preferably in excess of 3V. Most EC devices in this disclosure will operate in the range of 0.8 to 6V. These will be called ion-reactive layers as they react with the ions and then do not release them.

The ion-reactive layers may be formed from organic and organometallic materials. These ion-reactive layers may be used as counterelectrodes or even as irreversible ion traps located between the EC and the ion conductor layer. Silanes, such as epoxy silanes, amino silanes, mercapto silanes, methyl tetraorthosilicate, etc. may be used to form these layers. Silanes may be deposited from about 1% solutions in ethanol or methanol. Water or acids may also be added to pre-hydrolyse them. As an example this layer may be added between the EC layer and the ion conductor or be substituted with the ion conductor or be located between the counterelectrode and the transparent conductor. It was found that when using tungsten oxide as the EC layer, the silane coating allowed the ions to go through to color the EC layer, but was more difficult to bleach. Ion-reactive layers to trap lithium may also be made which comprise of crown ethers. Crown ethers are molecules which have cavities of just the right size to trap ions or molecules. Thus, appropriate crown ether should be one that can trap lithium. A crown ether suitable for trapping lithium has a cavity size of about 0.085 nm such as 15-crown-5 (15C5) available from Sigma Aldrich (Milwaukee, Wis.). To form a layer comprising crown ethers, these crown ethers may be mixed with the silanes or introduced in matrices of polyethylene oxide and/or polypropylene oxide or other ion-conducting polymers described above. In one method polypropylene glycol may be mixed with crown ether and a curing agent based on an epoxy or an isocyanate. This mixture is deposited by spin coating or other method and cured (e.g. cross-linked) into a solid film. In some example constructions, formulations may be made, which are UV cured, by using polypropylene glycols which are terminated by methacrylic or acrylic groups (including epoxy and urethane acrylates), adding UV initiators and curing them after deposition. One may also use alternative formulations which are solidified upon cooling (commonly called hot glue) or those materials which are processed like hot glue to give immediate green strength for handling, but can be further cured by UV or by mechanisms using room-temperature vulcanizates (RTVs). For trapping ions one may also use materials that get reversibly or irreversibly reduced, e.g., peroxides, disulfides, manganates, chromates and dichromates, etc, which may be also put in the matrices as are crown ethers.

The development of an electrochromic device which is stable in both the dark and bleached form requires a fine tuning of the half cell potentials of redox species. The bleached oxidizing agent and reducing agent must result in a cell potential of less than of equal to zero. This can generally be calculated using the Nernst equation. However, in the search for a device which is stable in both the bleached and dark state the cell potential for the reverse reaction must also be less than or equal to zero. Such a set of oxidizing agent and reducing agents is required for such as system.

An alternative approach to this system is to select either the oxidizing agent or reducing agent to undergo an irreversible reaction. This will prevent any possibility for the establishment of a galvanic cell upon electrochemical switching. This will of course produce a single use electrochemical device. Simple examples would include chemical species which converted to gasses or are precipitated upon undergoing the redox reaction. In an electrochromic device such reactions are not practical, other systems must be considered. Systems which undergo a chemical change through the addition or removal of an electron are desirable. Such systems may undergo dimerization or polymerization, add a ligand or undergo a significant structural change.

Electrochemical polymerizations are generally employed to produce conducting polymers. However, use of the monomers as the reducing agent in an electrochemical cell should produce an irreversible electrochemical device. Pyrroles, thiophenes, anilines and furans have all been shown to undergo electrochemical polymerization. The oxidizing potential of the monomer can be controlled by relative electronegativity of the monomer. Careful selection of the monomer will enable development of an electrolytic cell where there is no possibility of forming a galvanic cell after a potential has been applied

Other possibilities involve a chemical change such as the formation of bonds in the thiol to disulfide conversion. Others would involve a geometric change in a metal complex, such as a tetrahedral to octahedral change in geometry. Many examples of complexes which undergo such changes are know, examples include Cu(I)→Cu(II) and Co(II)→Co(III). In inorganic chemistry other systems where a change in the coordination sphere occurs on oxidation or reduction. Examples include species where oxide ligands leave or enter the coordination sphere such as MnO→Mn2+, VO2+→VO2+.

Electronic leakage through the device can be controlled by the choice of ion conductor, one such choice is use of ionic layers in between the EC and the inorganic ion conductor or as a replacement of the ion conductor. Examples of ionic layers being poly(sodium 4 styrene sulfonate) and poly(lithium 4 styrene sulfonate), polyamps, Nafion™ and ionomers (e.g., Surlyn® from Dupont (Wilmington, Del.)). These materials are generally described in U.S. Pat. No. 6,178,034. For EC devices where they are activated to a bleached state, and it is desired that this state be maintained for a limited time (few hours to a few days or even weeks), reversible type EC devices are preferred. These devices can be made to revert back to a more colored state by manipulating the ion-conductor so that it has a finite electronic conductivity. Alternatively, the two electrodes may also be joined by a high resistance element in excess of about 100,000 ohms to tune the desired amount of “open state” time. Typically, a thinner ion conductor will have lower electronic resistance, thus more leakage current. Also the microstructure of the ion conductor may be manipulated, e.g., a given ion conductor when deposited in a more dense form will have lower ionic conductivity if the other parameters are held constant. Even with devices with no driving potential, color may be lost because of oxidation, particularly for those layers where coloration occurs in reduced state. Processing conditions, e.g., sputtering or evaporation under high pressures leads to higher porosity, use of elevated temperatures and use of ion-assisted deposition reduces porosity. One may also use materials which are colored in oxidized state, and these can be bleached, but over time revert back to the colored state due to oxygen diffusion in the product, an example of such EC material is polyaniline. It is preferred to encapsulate the EC devices with barrier layers so that permeation of oxygen and water is significantly reduced. Further, these materials may also lend to increased surface hardness. Several of these coatings are listed in other section where hard coats are discussed. Preferred permeation of oxygen or water through these layers at room temperature should be less than 3×10⁻⁵ ml cm²-day-atmosphere and less than 8×10⁻⁵ g/cm²-day at 90% relative humidity respectively. When EC layers, ion conductors and the counterelectrodes are deposited by physical vapor deposition, it is preferred that they have sufficiently open structures for ions to go through and have low stresses. For example, EC coating porosity is dependent on the ion to be transported. For example, the lithium ion (Lie) has a size of 0.076 nm and O²⁻ has a size of 0.145 nm (and O₂ is about 0.17 nm). The channel size should preferably be greater than about three times the ion diameter. Typically low density or more porous structures are produced at higher vapor pressures (keeping the other factors constant). Pressures in the range of 10⁻³ to 5×10⁻⁵ torr are generally preferred. The pressures are usually controlled by using oxygen, nitrogen and/or argon. A method to deposit organic layers or inorganic layers from liquid precursors is by printing of which a preferred approach is by using ink-jet printing techniques, or any other printing techniques including screen printing, offset and gravure printing methods. Several companies offer capabilities of ink jet printing on rigid substrates such as Litrex (Pleasanton, Calif.), Dimatix (Santa Clara, Calif.) and Microfab Technologies (Plano, Tex.). A combination of processes may be used to deposit multilayer devices, i.e., some by printing and the others by PVD or CVD. PVD is mainly used for metals and inorganic materials. However, increasing use of printing including ink-jet printing is being done for these materials. Typically nano-sized particles of metals or inorganic particles is dispersed in a liquid medium and used as ink. The particle sizes are generally less than 100 nm and more in the range of 5 to 20 nm. As an example formation of such particles in liquid phase are described in U.S. Pat. No. 6,322,901 and published US patent application 20050107478. Liquids comprising nano-particles of inorganic transparent conductors (such as ITO and IZO) and metals can be used for printing. For example Cabot (Billerica, Mass.), ULVAC Technologies Inc (Methuen, Mass.) and Harima (Japan) have nano-metal pastes (e.g., gold, silver, copper, etc) for printing. Also, the RF antennas as described later may also be printed (e.g., using ink jet printers) using these inks on the same substrates as the EC devices.

Transparent conducting oxides may be deposited by a number of methods. Preferred methods are those where these oxides may be deposited at high rates to keep up with rates similar to metal deposition in optical media to balance the throughput and minimize the number of discs going through the process at any given time. It is preferred that each layer of the conductive oxide or any other layer in the conductive stack is deposited at about less than 15 seconds, and more preferably in less than 5 seconds, and two to three seconds being most preferable. These are deposition times only and not the period for evacuation through load-lock, etc. Further, since the optical media substrate is made out of plastic (generally polycarbonate), it is preferred that the substrate temperature is at least 10 C below the glass transition temperature of the plastic material. For polycarbonate media a preferred range is below 130 C, and more preferably below 110 C, and most preferably below 100 C. One preferred method is to use Pulsed DC sputtering for high flux and simultaneous use of an auxiliary oxygen plasma when using an alloy target of the component metals (e.g., indium-tin or indium zinc, etc). The auxiliary plasma can be generated by radio frequency (e.g., 13.56 MHz) or by the use of microwaves. An example of pulsed DC power supply is Pinnacle Plus available from Advanced Energy (Fort Collins, Colo.). A ceramic target may also be used but one has to be careful about the thermal loading. To get high flux in a small area where the coating is to be deposited, hollow cathodes may be used rather than planar cathodes. The material is sputtered through an inner diameter of the target tube and the atoms exit from the end of this tube. This type of system also has high coating efficiency as very little material ends outside the desired coating zone. An important parameter is to achieve a high flux of ions with energy closer to about 20 eV/ion so that dense crystalline films are formed without being disturbed too much from the kinetic energy of the arriving ions.

For the access control, security, and theft protection as envisioned here, the most desirable EC device could maintain its colored and bleached state without having an appreciable potential in either state. This means voltages in any state of coloration should be lower than 0.5V and preferably less than 0.1V and most preferably zero volts. Thus these devices will have low or no internal driving potential which may lead to stable optical characteristics when stored for long periods of time. It is best to have devices exhibit this characteristic at all temperatures to which the optical media is to be subjected to. However, in case the devices change their optical state in a reasonable time at a temperature which is below the destruction of the optical media so that the protection of the media may be overcome, one can combine these devices with passive thermochromic layers. The thermochromic layer may be added to the EC device as a separate layer or a thermochromic material may be mixed with one of the layers comprising the EC device. In the latter case, one has to ensure that the functionality of the EC device is still acceptable. The function of the thermochromic layer will be to change its optical state to a dark color so that the optical media cannot be accessed. The temperature at which the thermochromic material transitions, will have to be chosen so that the consumer in regular use is not able to subject the optical media to this temperature. A preferred transition temperature is around and above 85° C. as one may achieve this temperature on a hot day at a closed automobile surface. A device with combined thermochromic and electrochromic properties may also function or warn an end user of its illegal acquisition or tampering. Further, the thermochromic material may also be disabled by an irreversible chemical reaction when the product is electrically activated by a legitimate application of voltage. Similarly an electrochromic material may be combined with a photochromic material. Where an unauthorized exposure to optical radiation may result in the bleaching of the electrochromic material, but the photochromic material would kick in to cause an irreversible change in the optical properties to render the object unusable or warn the user. One may combine electrochromic, thermochromic and photochromic materials, all in one package. Thus, one may use more than one type of change in a device to attain the objective of security and theft deterrence.

FIG. 3 shows an EC device 35 with four layers. The metal layer 36, EC layer 37, and the transparent conductor 39 are similar materials as described above with reference to FIG. 2. The ion-conductor 38 is used as a material that serves both as the electrolyte and as a material that can absorb the ions from the EC layer when powered. The layer 38 should not become electronically conductive when oxidized or reduced. Since, this does not have an electrode symmetry these can more readily form non-reversible devices. These devices can also be driven at high voltages where the ions react with layer 38 or even partially reduce the transparent conductor. Examples of such layers are those comprising silica, tantalum oxide, zirconium oxide, alumina and yittria. Since these materials 38 are non-conductive they are not expected to have any potential between the electrodes which will cause the ions to move away from or move into the EC layer. In the bleached state the ions react permanently, thus there is no driving force for the devices to become colored when the device is left standing without any applied potential. The EC layer may be reduced or oxidized in any one of the ways to obtain the initial coloration as described above. The CE layer may also be formed by using the organic or inorganic ion-conducting materials with irreversible or reversible redox materials.

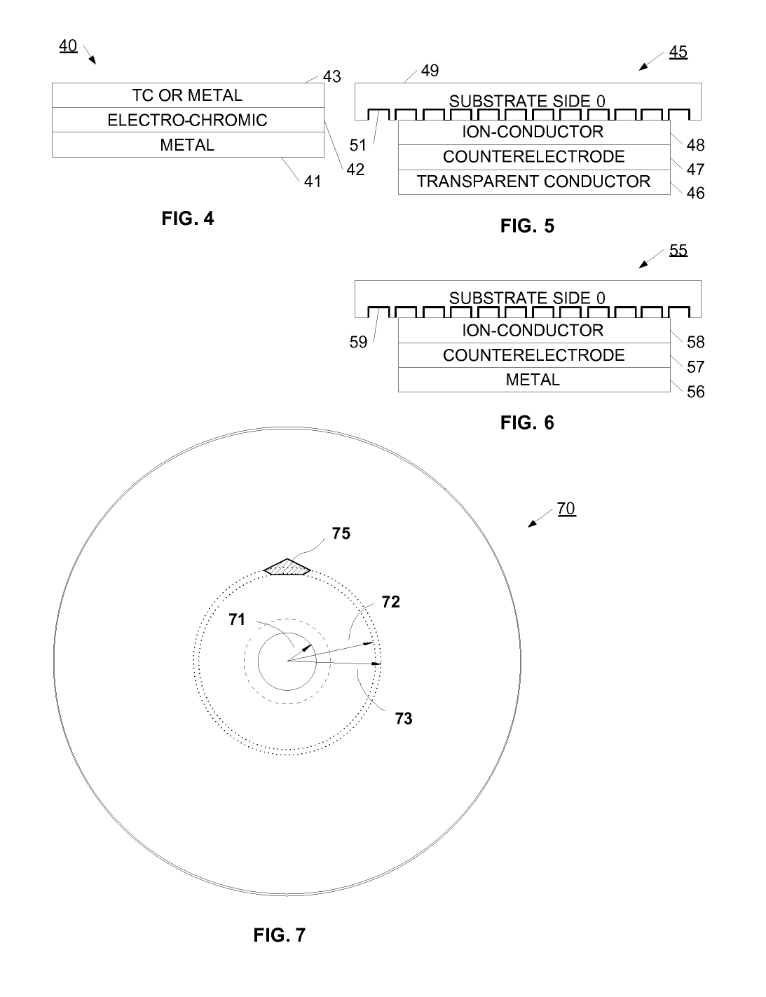

One may also make the device in FIG. 3 in an inverted sequence where counterelectrode layer 38 is first deposited on the metal electrode 36 followed by the EC layer 37 and then the transparent conductor 39. FIG. 4 shows another type of EC device 40 (thin film stack) which can be used for this purpose. In these devices those EC materials 42 are preferred that do not become conductive in either their colored or bleached states and thus do not cause a short between the two electrodes. The metal 41 and the transparent conductors 43 are similar as described above. Some of the preferred EC materials are molybdenum oxide. To bleach (when a potential is applied) the ions are irreversibly driven into the metal layer or the transparent conductor. When ions are driven in the transparent conductor, its conductivity may be reduced to a point that the device in non-operational after this change. One may add an insulating layer between the EC layer and one of the electrodes to ensure that there is no electrical short in the device this may be a thin layer of silica, zirconia, alumina, yittria or tantala in a thickness range of less than 50 nm.

There are other types of EC materials that may also be used where the metal layer itself participates in an EC reaction in going from transparent to reflective or vice versa. U.S. Patent Publication 20040021921 describes examples of these EC devices. Antimony/bismuth and silver-antimony, copper-antimony and antimony layers are preferred metals for this application where the metallic (reflective) state goes to a transparent state when injected with lithium. Further, the preferred range of antimony concentration (atomic %) in these alloys is from about 40% to about 90%. One may even use one of these compositions as one of the metal reflective layers as a substitute for gold or aluminum in FIG. 1, and then build an EC device on this layer.

These devices could be constructed as shown in FIG. 5 and FIG. 6. For example, the device 45 may be constructed as in FIG. 5, where the metal layer 51 is deposited on substrate 49 (readout side, see FIG. 1, this metal layer is substituted for the data layer (e.g., gold) in the EC device region or the entire disc). Further this metal layer is one of those metal compositions that changes from reflectance to the transparent state, then preferred thickness of less than 50 nm and a more preferred thickness is less than 30 nm. The electrolyte 48 is a lithium conductor such as lithium niobate, lithium tantalite, lithium silicate, lithium aluminosilicate, and lithium-phosphorous oxynitride (LIPON) in a thickness of about 50 to 500 nm. The counterelectrode 47 is a material that is transparent in its reduced state, example being lithium doped cerium-titanium oxide, lithium doped titanium vanadium, lithium aluminum fluoride doped with oxides such as titanium oxide and molybdenum oxide may also be used in a thickness range of about 100 to 500 nm. This is followed by a transparent conductor layer 46 as described before. In these devices lithium is inserted into the counterelectrode in several ways as described above, such as co-deposition, chemical or electrochemical reduction or depositing lithium as a separate layer which is then diffused in the CE by heat, time or by applying a mild potential across the electrodes. If this metal 51 is the same as the reflective layer in FIG. 1, then this layer (in the active EC device region) is lithiated by inserting the lithium ions so that it becomes transparent. Thus in the transparent state (which will be closed state for this device) the data is not read in Layer 0 (See FIG. 1) as the reading laser beam passes through. When this layer is subjected to a positive potential compared to the transparent electrode then the lithium is driven out and it becomes reflective to an extent that there is sufficient reflection from this layer to read the data and also transmit enough laser power to be able to read underlying layers.

One may also invert the layers for the device 55 as shown below in FIG. 6 which also uses two metal layers. Metal 56 is the gold layer, and metal 59 is the metal layer which changes from the transparent to the reflective state deposited on the substrate, and the description of the ion conductor 58 and the counterelectrode 57 remains the same as in FIG. 5. This type of an EC device may also be put on the readout side of layer 1 (FIG. 1) starting with a metal layer 59 such as gold in FIG. 6. All the other layers are subsequently deposited and the EC metal layer 56 is deposited in the EC active region so that it could change from transparent to reflective. The counterelectrode 57 may contain the lithium incorporated in one of the several ways discussed above. The device when activated will cause the lithium to be injected into the reflective layer 56 in the EC device area to be clear and be able to read data. When Lithium is expelled it becomes reflective to the point that either none of the reading laser intensity passes through it and is unable to read data on any of the layers masked by the EC layer, or changes to a reflective state which is so poor that even the data on the readout side of Layer 0 is unreadable.

Another example optical device uses at least two electrodes with a polymer comprising electrolyte in between Preferably these are two of the metal layers used for data layers. If the data layers are the two halves of the disc as shown in FIG. 1, the bonding agent may serve as the electrolyte or will have electrolytic components in the device region. The electrolyte may comprise of an electrochromic material which may be anodic, cathodic or may have both of these characteristics. Some of these materials are described in US patent applications 2003/0234379, 2004/0257633 and in US patent 6853472. In an example EC device, a pH change is activated (acidic or basic) directly in the electrolyte layer, causing one of the metal (i.e., electrode) layer to gradually dissolve away making the data on that electrode (layer) unusable. This dissolution may not be a physical dissolution, but dissolution by creating a more soluble metal species (or metal compound) formed as a result of the electrochemical reaction. The formation of this chemical compound may not be reversible. In solid devices the kinetics of forming solid solutions may be so low, that the optical transition may be observed only due to the formation of the new metal compound which is more transparent. In general, the EC layer (metal in this specific case) may be porous where the electrolyte penetrates these pores in addition to forming a layer on top of the EC layer. Porosity can allow for a faster interaction between the two layers. The electrolyte although is a solid may have liquid or flexible components which plasticizes the electrolyte matrix and allow faster kinetics. One may further add reactive materials to the electrolytes where this pH change causes them to change their optical properties Further these property changes may also be aided by moisture and/or oxygen diffusion into this layer from the ambient atmosphere. As an example if the data layers are aluminum and gold as the two electrodes forming the EC device, the aluminum will corrode due to an oxidation reaction caused by pH change as given by the following scheme:

Al→Al+3+3e- and Al+3+3OH—→Al(OH)3

The change to Aluminum hydroxide causes loss in reflection. The oxidation reaction in the electrolyte in acidic medium (pH lower than 7) leads to the following balancing reaction where hydrogen will escape through the package

2H⁺+2e⁻→H₂

and in basic medium (pH higher than 7) may lead to the following balancing reaction in the electrolyte

O₂+2H₂O+2e⁻→4OH⁻

Other redox additives may also be added to the electrolyte which will lead to alternative balancing reactions. The electrolyte will also comprise polymeric, monomeric or oligomeric components (e.g., acrylates and methacrylates including urethane and epoxy acrylates). The layers are typically put down from a liquid or a vapor precursor. Solid layers are obtained by polymerization of the material in the layer or evaporation of a solvent. The curing or polymerization may be done by radiation (UV, microwave, etc.) and or heat. Depending on the mechanism of cure appropriate initiators may also be added as commonly known in the art. One may also use alternative polymeric formulations as a matrix which are solidified upon cooling (commonly called hot glue) or those materials which are processed like hot glue to give immediate green strength for handling, but can be further cured by UV or by mechanisms using room-temperature vulcanizates (RTVs).

In the above description it was assumed that the EC is located between the two halves of the DVD. Another highly preferred location is outside of the DVD on the read-out side (see FIG. 1). The thickness of the EC device (including conductive layers) is preferred to be less than 10 microns, more preferably less than 5 microns and most preferable less than 2 microns. The EC device may be covered by a clear hard coat which could be deposited by liquid precursors or from vapor phase such as PVD and CVD and may be assisted by plasma energy. The preferred thickness of the hard coat is from 0.015 to 10 microns. Silicon, zirconium and aluminum containing materials are preferred for the hard coating. Preferred examples are silica, zirconia and alumina. The hard coats may also be deposited by liquid processes (e.g., spin coating) that form crosslinked polymers, typically acrylates and/or silicones. These may be crosslinked using thermal or radiation (such as UV) activation. These may also comprise of hard nano-particles (typically 5 to 50 nm in size), some of these are metal oxides such as silica, alumina and zirconia. An example is a spin coatable hard coating from TDK (Japan) is DURABIS PRO such as PD-RE23CN. Hard coats deposited by plasma processes from chemical vapors are also available from Exatec (Wixom, Mich.) and Schott-HiCotec (Elmsford, N.Y.). These hard coats also provide the barrier against moisture and oxygen permeability.

Placement of the EO Device on a Disc and Integration with Other Components:

FIG. 7 shows a DVD 70 with a central hole radius 71 for the disc, the lead-in radius 72 and the radius for the beginning of the program or data area 73. Typical dimensions for these in a commercial DVD are 7.5, 22.6 and 24 mm, respectively. The burst cutting area, clamping and the inner guard have diameters respectively smaller than the lead-in area (not shown). Also shown is an EC device 75 placed to cover part of the lead-in and the program area. The EC device may be placed as such, or all within the lead-in area or only in the program area. It may have a variety of shapes or patterns as discussed later. The lead-in area is an area proceeding the data area that typically holds important information for data access, such as sector, menu, and control information.

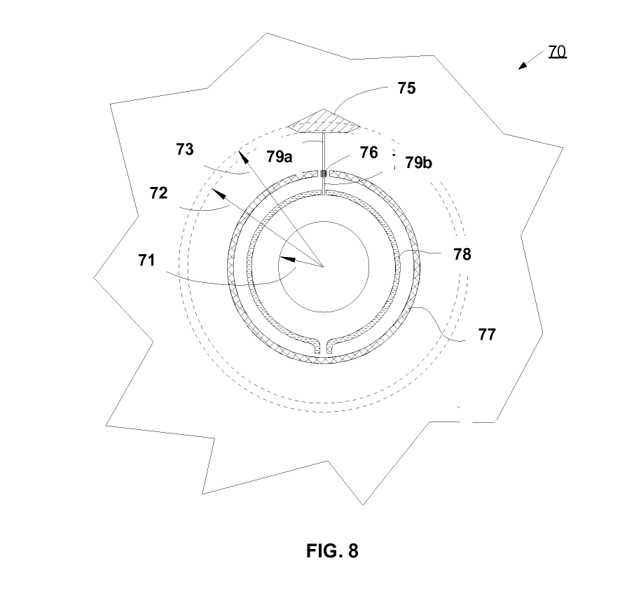

FIG. 8 shows the central part of the disc 70 (expanded from FIG. 7 with more detailed features). In addition to the EC device 75, the central hole radius 71 and the start of the lead-in 72 and the program area 73 radii, it also shows a microchip 76 electrically connected to the EC device via connection trace 79a and also connected to an antenna 78 via connection trace 79b. The microchip is located in the stacking ring area 77. The anti-theft mechanism works in the following way. The EC device is in the blocking or off-state when the optical media leaves the manufacturing facility. Upon purchase of the optical media by the end user, the chip, using the antenna communicates, via an RF or any other wireless source, with a central network to authenticate the transaction. Once the chip 76 receives an authenticating signal, the chip applies a bleaching power to the EC device so that it goes to an open state, or a state in which the laser beam in a player is able to access the data on the disc.

The powering integrated circuit (IC) 76, or “chip” as it is commonly known, is placed anywhere before the start of the lead-in area. However, a convenient place for it to reside is the stacking ring area 77. During the disc molding operation, a part of the stacking ring is not molded to accommodate the chip. Typically the chip may be about 5 to 100 microns in thickness (more likely 50 to 80 microns), so that it does not protrude beyond the stacking ring thickness. Its width and length are preferably less than 2 mm by 2 mm or more preferably less than 1 mm by 1 mm. The antenna is placed also within the inside part of the lead-in (before its start), and preferably within the region inside of the stacking ring area so that it is away from metal layers comprising the media, which generally do not extend inside of the stacking ring. The antenna may also be formed on a separate substrate such as a polymeric film of polyester but electrically connected to the chip. The end-user after purchasing and then opening the package may pull on the antenna substrate, dislodge that and throw it away. There may be convenient tear areas located so that it is easy to dislodge the antenna or it may be affixed using tapes and adhesives which are easy to tear. In one example, the antenna is removably adhered to antenna contacts on the disc using a z-axis conduction tape as described earlier.

A preferred chip is a flip chip geometry that has solder bumps and may be assembled using conductive adhesive or solders to electrical connections from the EC device or the antenna. The connections from the EC device may be metal lines or transparent conductor lines that culminate in pads for the chip. The conductive adhesive or the solder may be cured/fused thermally, by radiation, friction, laser or by ultrasonic processes. One may also assemble the flip chips using Z-axis conductive adhesives as discussed earlier, where solder bumps and underfill adhesives will not be required.

The power to the IC may be supplied by a thin film battery (not shown) which may be located near the IC or be built into the IC. The power may also be supplied by coupling the antenna to an RF power source. The IC is expected to deliver a voltage in the range of 1 to 5V, preferably in the range of 1.5 to 3.5V. The IC is preferably configured to deliver power for about less than 10 sec, and more preferably for about less than 5 sec and most preferably for about less than 2 sec. This time period is to allow the EC device to change its state of optical characteristics to a different optical state. The change in the optical properties of the EC device may occur only while the power is applied or they may continue for a long period (minutes to hours) after the activating power has been applied. It is preferred that the device in the open state (i.e., when the access to the data is allowed) pass or reflect greater than 20% of the reading laser intensity as compared to a data region where there is no EC device. A more preferred number is greater than 60% and most preferred is greater than 85%. A higher transmission will allow the laser to scan flawlessly from the EC region to the rest of the DVD. Similarly, the closed state of the device (where it is unable to access data) should transmit or reflect less than 20% of the laser intensity compared to a data region where EC device is not present. More preferably this number should be less than 20% and most preferably less than 5%. These numbers are measured using the wavelengths of the reading laser which is dependent on the type of media.

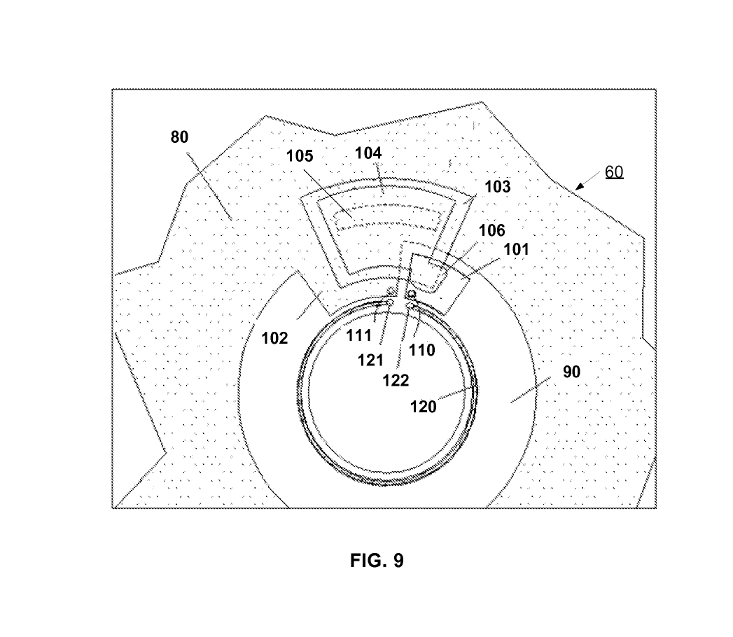

FIG. 9 shows an expanded view of the arced EC device. In FIG. 9, 80 is the burst cutting, lead-in and the data area, and 90 is the stacking ring, clamping and the inner guard area. Deposition of various layers and connectivity to a powering IC are demonstrated using a four-layer device as shown in FIG. 3. The EC device is constructed by depositing gold in area 80 and also some parts of 90 as shown by the shaded area 101 and 102. There is no electrical continuity between area 101 and 102. This can be done through a mask or coating the entire disk with gold and then using photolithography to remove gold from selected areas. This gold layer may be the metallic layer L0 in FIG. 1 if the EC device is being deposited inside the DVD halves and using gold as one of the EC electrodes. This may also be a transparent conductor which may be deposited inside or on the outside surface of the device. The EC device is shown as 60, of which the active electrochromic area is shown as 105. Next EC material 105 is deposited, which may be tungsten oxide by sputtering. It will be appreciated that other EC materials and disposition process may be used. This layer may be colored by co-depositing lithium or depositing lithium as an additional layer which is later intercalated. One way to deposit lithium is by using a lithium-aluminum alloy target, where the sputtering/or evaporation conditions selectively remove lithium. Alternatively using a solution of strong reducing agent such as butyl-lithium may chemically reduce tungsten oxide. This layer is deposited through a mask in a selected area. This is then covered using a larger mask with layer 103 which is an electrolyte and counterelectrode shown as 103. Finally a layer of ITO 104 (transparent conductor) is deposited using a smaller mask as compared to layer 103. Care should be taken that the TC does not touch the gold layer in any region other than in area 101 as shown by 106. As illustrated, bump 110 and bump 111 are the contact points where the IC chip is connected to the device using a conductive adhesive, bump connections, or some other means. The figure also shows an RF antenna 120, which is connected to the IC chip (not shown) via the connection pads 121 and 122.

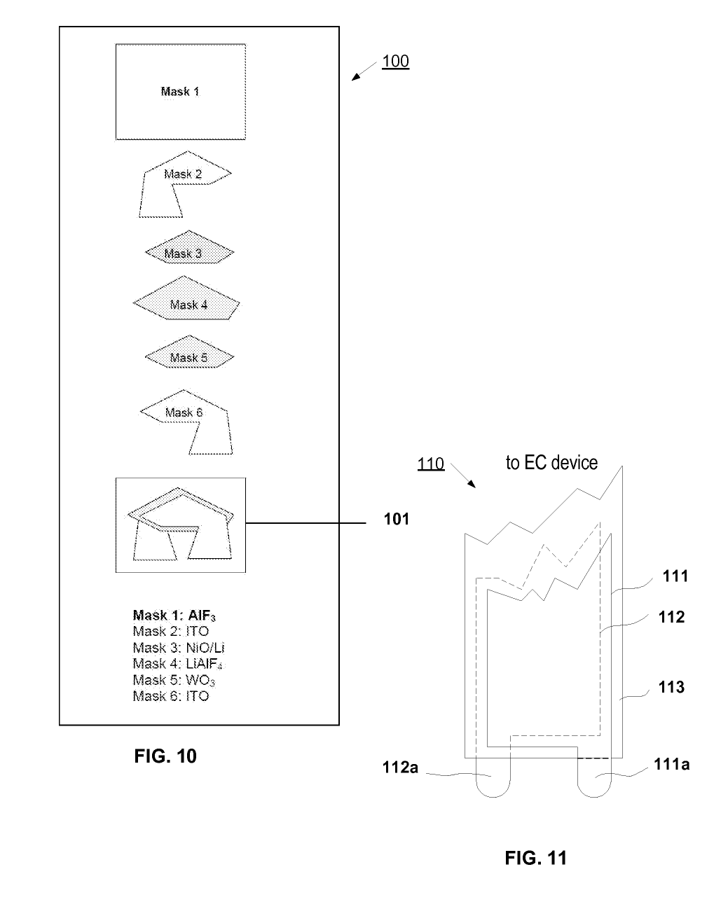

FIG. 10 shows a masking system 100 for forming an EC device with connections to be able to connect with other components. This device is deposited on the outside surface comprising of two transparent conductor electrodes made out of ITO. This deposition is also conducted using PVD for illustrative purposes. Layer 1 made of aluminum fluoride is deposited through a rectangular Mask 1. This acts as adhesion promoter between the polycarbonate surface of DVD and that of the next ITO layer. The first ITO layer is deposited through Mask 2. This is followed by nickel oxide deposited through Mask 3 (the shape of the active EC area). Through the same mask lithium is evaporated to dope nickel oxide. Mask 4 is larger than Mask 3 and it is used to deposit the ion conductor LiAlF4. This ensures that there will be no short between the bottom layers and the layers to be deposited on top of it. Through Mask 5, which may be the same as Mask 3, tungsten oxide is deposited. Finally through Mask 6 the second ITO layer is deposited, thus completing the device. As shown in the composite 101 in FIG. 10, the two ITO layers are separated at the bottom which may be connected to the other components. Mask 3 and Mask 5 are not shown in this composite as they are hidden behind other layers. It will be appreciated that other materials may be substituted as previously described.

An alternative connection scheme 110 is shown in FIG. 11 where the two ITO layers 111 and 112 are on top of each other and an insulating layer 113 between them keeps these from shorting. The insulating layer may also be the ion conductor of the EC device. In this figure the two ITO layers are shown with slight stagger only to be able to illustrate the point, however, they can completely overlap one another, and only come out as separate pads at the bottom shown by 111a and 112a. The areas of these protrusions are just sufficient for these to be bonded to the chip. In this geometry it is difficult to access the two ITO paths from outside through probes, to bleach the EC device.

When the EC device and the chip and the antenna are located between the two halves of the DVD to accommodate the thickness of the IC, the one half may be molded with an indentation and then properly oriented and placed on the other half for bonding. Alternatively, one may have an indentation on the same half where the IC is placed, and the coatings operation of the metal layer and the TC is done so that it extends into the indentation. The pads on the IC may be bonded using conductive adhesives or using low melting point solders such as those based on indium. The conductive adhesives may be rigid such as based on epoxies or be flexible using silicone matrices. A variety of these are available from many sources, and one source being Emerson and Cummings (Billerica, Mass.). The same IC may have additional bonding points to contact the RF antenna and associated circuitry if used. In another alternative the IC may be embedded in the same half which has the EC device with only the contact points exposed so that the layers when deposited come in contact with these exposed contacts. The IC may be embedded during the molding operation. Further using injection molding technologies such as those used for molded interconnected devices (MID) and three dimensional MID (3D-MID) one may embed ICs and antennas which are connected and also allow tracks on the substrate to connect to the EC device electrodes as they are formed.

One may also form a complete EC device using thin metal layers or transparent conductors on polymeric film, preferably of a material that is used to manufacture the disc, some of the films which may be used are polycarbonate, acrylic, polyester, polyethyleneterephthalate or the cyclic polyolefin. These films should preferably be heat stabilized. The polymeric film thickness is usually less than 150 microns on which the multilayer device is deposited. Optionally, the IC and the antenna can also be assembled on the same film. This is then placed between the two discs (the bonding area, see FIG. 1) but roughly located in a region as shown in FIGS. 8 and 9. To accommodate the thickness of the film, antenna and the IC, one may make provision of this during the molding or stamping operation. One may only make the provision to accommodate the IC and antenna thickness if the film thickness will be accommodated within the bonding layer. Alternatively, the film with the device and all the other components is placed on the outside surface of the bonded disk. One may use molded interconnect device (MID) technologies to integrate all or part of these components, form electrical connections with each other and be assembled on to the disks (e.g. see MIDs Make a Comeback http://www.plasticstechnology.com/articles/200506fa 1.html, by Joseph A. Grande Plastics Technology, June, 2005). Antennas and EC films and other components may also be formed on a substrate and transferred to the injection molded discs using a technology called In-mold decoration (Nissha, Japan) or see PCT application WO 2004085130. When EC devices along with electronics and antenna are placed in a disc, it may desirable to ensure that the disc is dynamically balanced as the disc is required to spin at high speeds in the playback equipment. On technique for doing so is to add counterweights, remove material (e.g. polycarbonate) and replace it with lighter materials or leave a void.

### EXAMPLES OF EC MATERIALS AND DEVICES

### Example 1

### EC Device with MoO3+AlF3 Counterelectrode Processed by PVD

A set of four EC devices were fabricated on a conductive tin oxide coated glass by depositing coatings using physical vapor deposition (PVD). This was a five layer device similar to the one shown in FIG. 2 comprising of an EC layer, ion conductor and a counterelectrode sandwiched between two conductors. The devices were appropriately masked from each other to generate four independent devices in a size of about 1.5 cm×1.5 cm. The first layer was 500 nm tungsten oxide evaporated by an electron beam. Then 60 nm thick lithium metal was evaporated to dope and reduce tungsten oxide to its colored bronze (corresponding to about 24 mC/sq.cm of charge). An ion conductor comprising aluminum fluoride and lithium was deposited next in a thickness of 500 nm. This was followed by a counter electrode comprising about equal proportions of molybdenum oxide and aluminum fluoride in a thickness of 100 nm and the top conductor which was 9.5 nm thick gold layer. The device as fabricated was colored and when 1.5V was applied (gold electrode being negative) the device bleached. The colored transmission at 650 nm was 4.4% and bleached transmission was 20.5%. In a separate experiment the transmission of a 9.5 nm gold coating on glass was measured to be 42% at 650 nm.

### Example 2

### EC Device with NiO Counterelectrode Processed by PVD

Another set of devices was fabricated as in Example 1. however, in this case the counterelectrode was 120 nm thick nickel oxide. At 650 nm, this device in colored state was 2.6% transmitting and in the bleached state the transmission was 15.1%. The colored state transmission at 405 nm was 6.9% and 22.6% when bleached.

### Example 3

### Electrochromic Polyaniline (PA) Coating

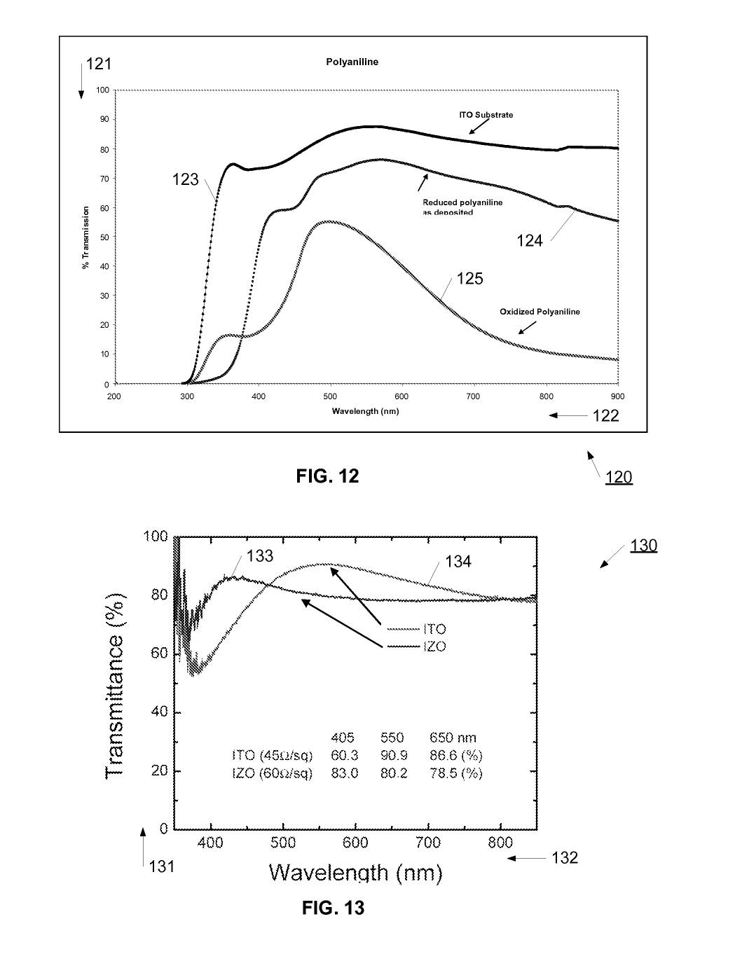

PA was deposited on ITO coated glass. The coating was deposited from a solution comprising formic acid and ascorbic acid. The coated substrate was heated to 70° C. for 15 minutes to remove the volatile products and solidify the coating. The 300 nm thick coatings were colorless as produced and were electrochromic as shown in FIG. 12 and the table below. FIG. 12 has a graph 120 that shows a % Transmission 121 versus wavelength 122 for the ITO substrate 123, the reduced PA 124, and the oxidized PA 125.

| % Transmission at | | |
|---|---|---|
| 650 nm | 550 nm | 405 nm |

Polyaniline

| | | | |
|---|---|---|---|
| Bleached | 71.6 | 75.8 | 52.8 |
| Colored | 28.7 | 50.0 | 18.2 |
| ITO substrate only | 84.0 | 87.7 | 73.4 |

### Example 4

### Transparent Conductor Coatings for the EC Devices

Two type of coatings, Indium tin oxide (with about 0.1 as tin to indium atomic ratio) and indium-zinc oxide (with about 0.3 zinc to indium ratio). These coatings were deposited on glass without heating. These coatings were deposited by sputter coating process in a thickness of about 100 nm. The resistivity of ITO was 45 ohms/square and of the IZO 60 ohms/square. Their optical transmission spectra is shown in FIG. 13. FIG. 13 has a graph 130 that shows a % Transmission 131 versus wavelength 132. It appears that for devices using light sources at 405 nm, IZO 133 will be preferred over ITO 134 from an optical perspective. In FIG. 12, the transmission of ITO was high at 405 nm indicating that the transmission of this layer is also morphology dependent which for a given composition can be controlled by the processing parameters.

### Example 5

### Solution Deposited Tungsten Oxide Coating Reduced with Protons

A tungsten oxide coating on ITO (12Ω/sq) was prepared from a precursor solution. The precursor solution was prepared from 3 grams of peroxotungstic ester (PTE) dissolved in 30 mls of ethanol. The solution was spin coated at 1000 rpm onto ITO and cured under humid conditions to 135° C. The WO3 coating had a thickness of 250 nm. This coating was chemically reduced to a colored state by subjecting this to dilute sulfuric acid and indium metal.

### Example 6

### Ion Conducting Layer Cured by Radical Polymerization Using UV Light

A UV curable solid electrolyte was prepared by mixing 3.75 g of poly(propylene glycol) diacrylate with 1.25 g of poly(propylene glycol) acrylate and 0.2 g of the UV initiator Irgacure 500 (supplied by Ciba Specialty Chemicals Corp. White plains, N.Y.). To enhance the ionic conductivity of the mixture 0.77 g of 1-Butyl-1-methylpyrrolyidium 1,1,1-trifluoro-N—[(trifluoromethyl)sulfonyl]-methanesulfonamide ionic liquid and 0.16 g of lithium trifluoromethanesulfonate. A thin coating of the mixture was cured to a solid film by exposing this for 5 seconds in a Xenon strobe light curing system (Model 550 from Electro-lite Corporation (Danbury, Conn.)).

### Example 7

### Ion Conducting/Electrochromic Layer Cured by Cationic Polymerization Using UV Light

A cationically cured cathodic layer was made using the following:
4 g of epoxy resin CyracureUVR-6105 (Dow chemical, Midland, Mich.)
0.717 g polypropylene polyol Voranol PT700 (Dow Chemical, Midland, Mich.)
0.189 g photoinitiator UV1 6976 (Dow Chemical, Midland, Mich.)
0.024 g silicone surfactant Silwet L-7604 (GE silicones, Scnechtady, N.Y.)
1.488 g 1-Butyl-1-methylpyrrolyidium1,1,1-trifluoro-N—[(trifluoromethyl)sulfonyl]-methanesulfonamide ionic liquid (or salt)
0.493 g diethyl viologen 1,1,1-trifluoro-N—[(trifluoromethyl)sulfonyl]-methanesulfonamide as the EC material
   This formulation was spin coated at 2000 rpm and cured under the Lesco Rocket Cure system (Torrance, Calif.) for approximately 60 seconds forming a 9 microns thick film. When this formulation was diluted with methanol much thinner coatings were prepared. These coatings were cured after methanol evaporated. When viologen salt was left out from the formulation, ion conducting coatings were obtained.

### Example 8

### Ion Conducting Layer Containing REDOX Species Cured by Radical Polymerization Using UV Light

A UV curable solid electrolyte was prepared by mixing 3.75 g of poly(propylene glycol) diacrylate (Mol. wt. 540) with 1.25 g of poly(propylene glycol) acrylate (Mol wt 475) and 0.5 g of dipentaerythritol pentaacrylate ester and 1.0 g of amine modified acrylate oligomer, acrylic ester. 0.4 g of the UV initiator Irgacure was added. 0.06 g of glycidoxypropyltriethoxysilane was added as an adhesion promoter. To enhance the ionic conductivity of the mixture 0.246 g of 1-Butyl-1-methylpyrrolyidium1,1,1-trifluoro-N—[(trifluoromethyl)sulfonyl]-methanesulfonamide salt and 0.046 g of lithium trifluoromethanesulfonate salt were added. The redox species ferrocene was added in a concentration of 0.282 g. This mixture was spin coated on glass and cured for 5 seconds in a Xenon strobe light curing system (Model 550 from Electro-lite Corporation (Danbury, Conn.)). The film thickness was 9 μm

### Example 9

### Electrochromic Device with Tungsten Oxide UV Cured Layers and Gold Electrode

A thin layer of the ion conducting material describe in Example 8 above was spin coated at 1000 rpm onto tungsten oxide as described in Example 5, but without the reduction step. The ion conducting layer was cured under UV to give a solid layer 9 microns thick. On top of this layer was deposited 50 nm of gold by a sputtering process to complete the stack and form the top electrode. The cell had an initial reflectivity of 68% at 650 nm and when colored by applying 3.5 volts had a reflectivity of 31%.

### Example 10

### Laminated Solid State Lithium Electrochromic Device

A solid state electrochromic device was constructed using a tungsten oxide coating as described in Example 5 above except the WO3 was cured at 250° C. and the coating was reduced in a three electrode configuration using 0.1M lithium trifluoromethanesulfonate and 0.05M ferrocene in propylene carbonate as the electrolyte. The reference electrode was a silver wire. The reduced WO3 on ITO was laminated with another ITO coated substrate through use of the ion conducting layer as described in Example 6. This bonding layer was cured under UV and had a thickness of around 30 μm. The initial transmission of the cell at 650 nm was 55% and when bleached at 3.5 Volts at room temperature its transmission increased to 80%. This cell in the bleached state along with another cell in the colored state (50% T at 650 nm) were stored at room temperature for three days without applying any electrical power. Both the cells did not show any optical change. To see if elevated temperature storage would accelerate a change in optical properties, both of these cells were then subjected to 85° C. for six days without power application. Again no change in optical properties was observed with no change in its optical transmission. This shows that in both cases the optical states were maintained without applying any electrical power.

### Example 11

### Laminated Solid State Proton Electrochromic Device

An electrochromic device was prepared as described in example 10 above except that the WO3 layer was cured at 135° C. and reduced with protons using dilute sulfuric acid and indium metal. The cell at 650 nm had a transmission of 3% and when bleached at 4.0 volts had a transmission of 78%. This cell was placed in the bleach state at 85° C. for six days with no change in transmission or physical appearance of the cell.

### Example 12

### Thin Film EC Device with UV Cured Electrolyte

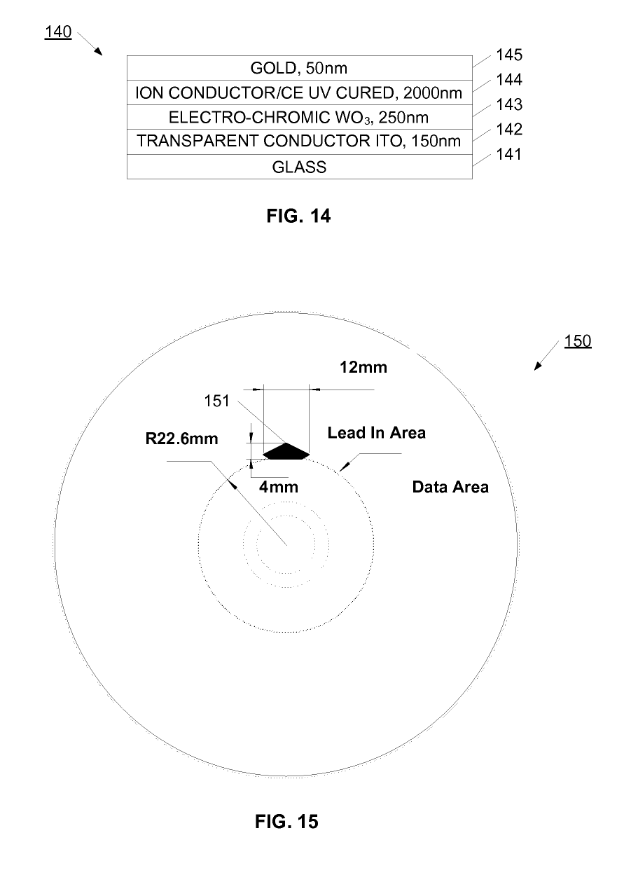

An electrochromic device 140 was made by depositing thin layers as shown in FIG. 14. The substrate used was glass 141, but it could have been a DVD substrate such as polycarbonate. ITO layer 142 was 150 nm thick with a conductivity of 15 ohms/square. This was followed by 250 nm tungsten oxide layer 143 which was deposited and reduced by the method described in example 5. The ion conductor layer 144 was formed by using a standard DVD bonding adhesive Dicure Clear EX 7000 (from Dinippon Ink and chemicals, Japan) and mixing this with 01M1-Butyl-1-methylpyrrolyidium1,1,1-trifluoro-N—[(trifluoromethyl)sulfonyl]-methanesulfonamide (ionic liquid or salt) and 0.1M 15-crown-5 ether. The thickness of this layer was 2 μm, followed by a top gold electrode 145 in a thickness of 50 nm. Gold could also have been replaced by a transparent conductor in about the same thickness. This device was colored blue as observed in reflection through the clear substrate. When a potential of 3V was applied to the device (Gold being negative compared to the ITO) the device bleached.

### Example 13

### EC Device on a DVD

FIG. 15 shows a DVD 150 with an EC device 151 in the shape of a truncated diamond. This EC device 151 was made by physical vapor deposition of several layers as shown below on the outside surface of a pre-bonded DVD.

Disk (Polycarbonate)/ITO(1)/LiNiO/LiALF4/WO3/ITO(2)

ITO(1): 100 nm

NiO: 100 nm

Li: 10 mC/cm2

LiAlF4: 750 nm

WO3: 300 nm

ITO (2): 50 nm

The device could be colored or bleached by applying 1V. For coloration ITO(2) was negative, and the polarity was reversed for bleaching. In the colored state the DVD did not play on a computer DVD player. In the bleached state the DVD played normally.

### Example 14

### EC Device with High Stability in Colored and Bleached State

A device was made using two pieces of glass with ITO coatings. On one of these a polyaniline coating in a thickness of 700 nm was deposited on a spin coater at 200 rpm as described in Example 3. This was assembled in a cell with a liquid electrolyte comprising of propylene carbonate to the ionic liquid in a ratio of 4:1 and 0.25 molar hydroquinone. The ionic liquid was 1-Butyl-1-methylpyrrolyidium1,1,1-trifluoro-N—[(trifluoromethyl)sulfonyl]-methanesulfonamide and the other side being ITO on coated glass In principle the cell resembled FIG. 3 where the EC layer was polyaniline. The electrolyte thickness was about 70 microns. The transmission of the cell at 650 nm was 2%. The two transparent electrodes of the cell were shorted. There was no change in the cell optical properties for several days. The potential between the two electrodes was negligible. When a potential of 2V was applied with polyaniline side of the cell being negative, the cell transmission changed to about 30% in 7.5s. After bleaching the cell was shorted again. The transmission of the cell relaxed by a couple of percent to about 28% and then it did not change for several days. The potential between the two electrodes was not measurable (close to 0V) in this state.

### Example 15

### Formation of Solid Hydroquinone Materials and Coatings

A solid hydroquinone polymer was synthesized using an acetate (Ac) as shown below using ring opening metathesis polymerization (ROMP)

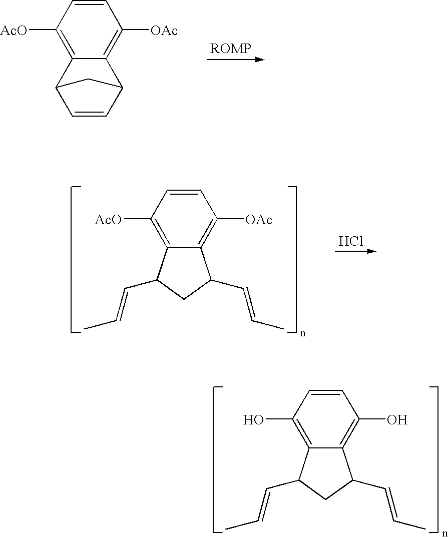

Another solid electrolyte containing hydroquinone was prepared by reacting 3.5 wt % poly(diallyldimethylammonium chloride) with 0.875 wt % hydroquinone in 50:50 water/ethanol mixture. The solution was spin coated onto ITO at 1000 rpm and cured at 80° C. to give a transparent colorless coating. The coating was 562 nm thick and contained 25 wt % hydroquinone based on the solid polymer content. The coatings were water clear. For this coating to be incorporated in an EC device, a polyaniline coating was over-coated with the hydroquinone comprising coating and stored for ninety minutes at 80° C. with no change in its optical transmission at 650 nm. Solid hydroquinone or coatings of other organic materials may also be formed by thermal evaporation of these materials in vacuum.

### Example 16

### Polyaniline Coatings Inside the DVD and Playability

Several DVDs were coated with polyaniline solutions (see example 3) by spraying through a mask to create a pattern as shown in FIG. 15. These patterns were created before the two halves of the DVD were bonded (see FIG. 1). The patterns were put directly on the metallic layer of the L0. In one case the transmission of the coating was 1% and in another case the coating was bleached with a transmission of 47% at 650 nm. The transmission measurements are reported by putting similar coatings on glass and measuring the transmission of the coated glass. The two halves i.e., coated L0 and non-coated L1 were bonded by a UV curing glue from DiNippon Ink (Japan) used for this purpose. Glue thickness was about 40 microns. The one with the colored pattern did not play on any of the following players and the bleached one played on all of these.

| | | |
|---|---|---|
| Panasonic (Japan), | Sony (Japan), | CyberHome (Fremont, CA), |
| Model DVDS29S | Model DVPNS50PS | Model CH-DVD500 |

### Example 17

### Polyaniline Doped with Hydroquinone (HQ)

A polyaniline coating was deposited by spin coating a solution (0.6 g of polyaniline (emeraldine base, 50,000 mol wt) in 20 ml of 88% formic acid) on an ITO coated glass substrate. The coating is dried in an air circulated oven at 80 C. The color of the coating as deposited is deep green and after the drying process it is deep blue. The coating thickness was about 300 nm. Doping with hydroquinone was achieved by soaking the polyaniline coating in a solution of 0.25M hydroquinone in 80 vol % propylene carbonate and 20 vol % ionic liquid at 80° C. for 5 minutes and then washed with ethanol. After doping, the polyaniline changed from deep blue to pale yellow. The coating had an active cyclic voltametry (CV) response and could be colored and bleached. CV was conducted in 0.1M lithium triflate solution in acetonitrile while using a stainless steel counter electrode and silver as pseudo-reference electrode. At a scan rate of 20 mV/s, the electrode was colored at −0.56V versus silver wire and the optical modulation was recorded as shown below.

Modulation Range of Hydroquinone Doped Polyaniline

| Polyaniline Doped with | 405 nm | 650 nm | 780 nm |
|---|---|---|---|
| Hydroquinone | % Transmission | | |
| Reduced | 54 | 66 | 63 |
| Oxidized | 3 | 7 | 1 |

The modulation of hydroquinone doped polyaniline was surprisingly high at 405 nm. Thus this was deemed as a suitable material at all the three wavelengths of interest. Further, this material had good thermal stability in both (colored and bleached states) as shown in the next table where the transmission change was recorded for both states by subjecting them to an air circulated oven at 80 C No change in colored state at 650 and 405 nm was observed for a period of two hours. In the bleached state the transmission at 650 nm decreased from about 66 to about 40% and at 405 nm this changed from 54 to 50%. It appeared that the change at the end of two hours was leveling off Derivatives of hydroquinone and their mixtures with hydroquinone were also found suitable to give large range at both 405 and 650 nm. For example in a separate experiment the following results were obtained.

| | 405 nm (% T) | | | 650 nm (% T) | | |
|---|---|---|---|---|---|---|
| Dopant | Reduced | Oxidized | Δ (405 nm) | Reduced | Oxidized | Δ (650 nm) |
| Hydroquinone | 42 | 7 | 35 | 57 | 15 | 42 |
| Trimethylhydroquinone | 49 | 27 | 22 | 65 | 58 | 7 |
| Hydroquinone/ | 45 | 14 | 31 | 62 | 51 | 11 |
| Trimethylhydroquinone | | | | | | |

### Example 18

### Solid EC Cell with Polyaniline Doped with HQ and with UV Curable Electrolyte Layer

A doped HQ containing polyaniline was prepared as in Example 17 on an ITO coated glass substrate and then incorporated in the device. Polyaniline was bleached when incorporated in the device. ITO conductivity was about 15 ohms/square. The substrate size was about 2 cm×2 cm and the area coated with polyaniline was about 0.75 sq cm. A layer of UV curable electrolyte with the following composition was coated on top of doped polyaniline:
7.5 g Poly(propylene glycol) diacrylate (mol. wt. 475)
2.5 g Poly(propylene glycol) acrylate (mol. wt. 540)
0.5 g Pentacrylate (SR399LV from Sartomer, Exton, Pa.)
0.05 g Amine(CN371 from Sartomer, Exton, Pa.)
0.46 g Irgacure 500 (from Ciba Specialty Chemicals, White Plains, N.Y.)
2.4 ml Propylene carbonate
1.0 ml 1-Butyl-1-methylpyrrolyidium1,1,1-trifluoro-N—[(trifluoromethyl)sulfonyl]-methanesulfonamide
0.1 g Lithium trifluoromethanesulfonate (0.05M)

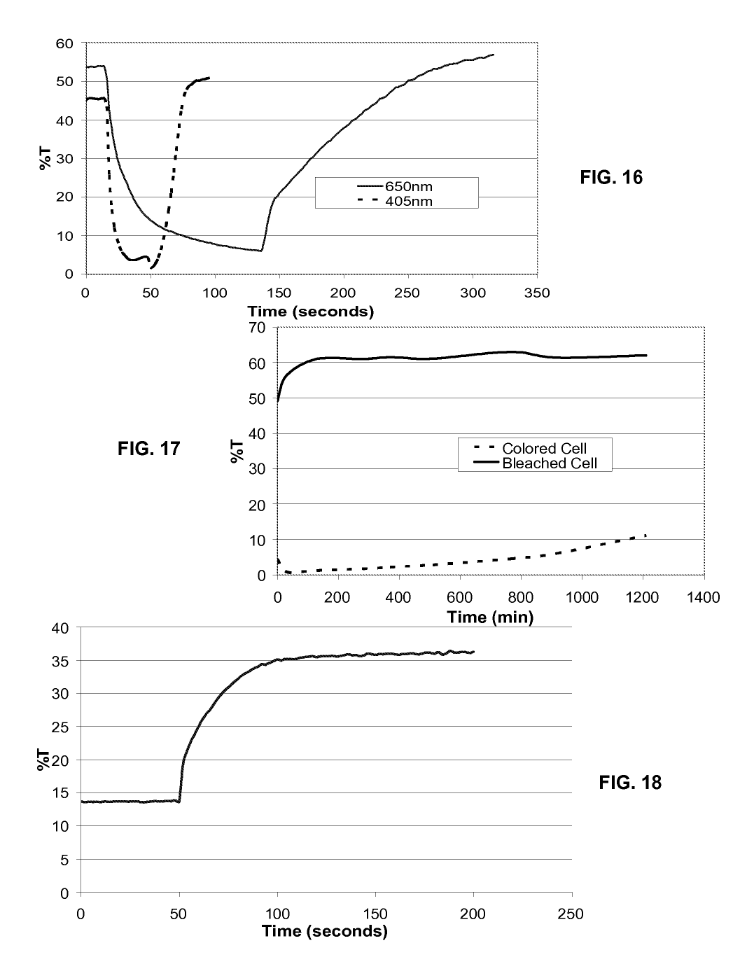

After coating with electrolyte another ITO coated glass of similar size, with a slight offset was lowered on top of the electrolyte with ITO touching this layer. The sandwich was then subjected to UV radiation for cure. The thickness of the electrolyte layer was about 1.5 microns. When a voltage of 2.75V was applied with polyaniline electrode being positive, the cell colored. The cell bleached when a reverse potential of 2.75V was applied. This is shown in FIG. 16 at 405 and 650 nm. The cell potential in colored and bleached state was 0 Volts. The cell was stored in colored state and a similar cell was stored in the bleached state at 80 C. Both of these were shorted when stored in either of the states. Their stability was high as seen from the change in transmission with time in FIG. 17.

### Example 19

### Additives to PANI to Improve its Adhesion to Other Coatings

For devices to work properly it is important that all layers must have good interface adhesion for proper transport of ions and electrons. We found that to improve the adhesion of polyaniline with other layers, particularly ion conducting layers deposited over it, that it is preferable to modify the polyaniline coating solution by adding ion-conducting material to it. For example addition of polymers with acid containing moieties, such as polyacrylic acid (PAA), Nafion® (Dupont, Wilmington, Del.), or polystyrene sulfonic acid was useful. The ion-conducting material coatings on top of modified polyaniline showed superior wetting during the coating operation. Further, the polymer added to polyaniline may be the same as the ion conducting layer or be a different one. The concentration of modifying polymer was preferably 50% of polyaniline by weight. A more preferred concentration was 10% or less.

### Example 20

### Devices with Polyaniline and Thiophene as Reductant

To make irreversible devices with no potential in the colored and the bleached states it was decided to couple non-reversible chemical reactions which were induced electrochemically. In these devices the expected reaction upon the application of bleach potential was electrochemical bleaching of the EC layer while a non-reversible polymerization was initiated of the thiophene. The devices were constructed with polyaniline (with 10% polyacrylic acid (molecular weight 2000) by weight). The coatings were deposited on ITO coated glass by spin coating from 88% formic acid solutions. The thiophene was dissolved in a polyelectrolyte (PSS (polystyrene sulfonic acid), Nafion™ or PSSNa (polystyrene sulfonic acid; sodium salt)). The nation solution was prepared in lower alcohols, the PSS and PSSNa solutions were prepared in water:ethanol 50:50. This was coated on a second ITO coated substrate, and these were assembled into a device by bringing the two coated substrates together and sandwiching an electrolyte. Initial experiments were carried out using liquid electrolytes which comprised of 0.1 molar lithium triflate in propylene carbonate. FIG. 18 shows that a cell made in this fashion with thiophene acetic acid had stable colored and bleached state when shorted. A similar cell was made where polyaniline was substituted with poly(2-methoxyanilne) and thiophene acetic acid was substituted with 2-nitrothiophene. This cell also showed good stability in both states.

### Example 21

### Devices with Polyaniline and Metal Salts as Reducing Agents

Devices are constructed with polyaniline coatings with similar compositions and process as in Example 19. The reductants are metal salts which are dissolved in a polyelectrolyte (PSS (polystyrene sulfonic acid), Nafion™ or PSSNa (polystyrene sulfonic acid; sodium salt)) in an aqueous solution comprising ethanol and water and coated on top of the polyaniline layer. To make a coating solution, 1 g of vanadyl sulfate was added to 2 g of polyacrylic acid and 8 ml of water. Then 0.1 ml of this was added to 0.5 ml ethanol and 0.5 ml of polystyrenesulfonic acid (18 wt % in water) to make the coating solution. The device was constructed where polyaniline was 300 nm thick, electrolyte was 2.9 microns thick and the top electrode was gold in a thickness of 60 nm. The device had an initial reflection of 8% which changed to about 27% when a potential of 2.8V (polyaniline being negative) was applied. This device exhibited stable states when shorted in bleached and color mode. The device had no measurable potential across the terminals in either of the optical states. Another device was constructed where cobalt chloride was used instead of vanadyl sulfate. This also showed stable optical characteristics in both states and the device changed from about 7% reflectivity to 18% reflectivity when bleached at 2.8V.

### Example 22

### Playability of Disks Coated with Polyaniline

Several polyaniline coatings were deposited in the pattern and position as shown in FIG. 13 on the read side of as many DVD9s by spray coating through a stencil. The transmittance of these coatings when deposited on glass was 14, 35, 57, and 62 and 79% at 650 nm. These were evaluated for playability for on a personal DVD player (Emprex Model PD 7001, Emprex Technologies, Fremont, Calif.). The disks with coatings having a transmission of 14 and 35% did not play, whereas the others did.

### Example 23

### Playability of Disks Coated with Open and Closed EC Shutters

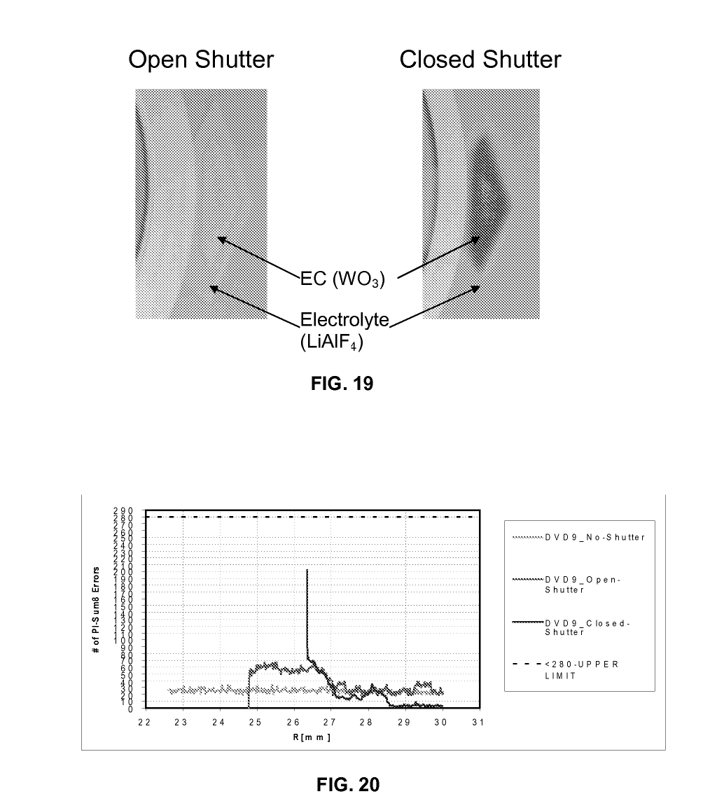

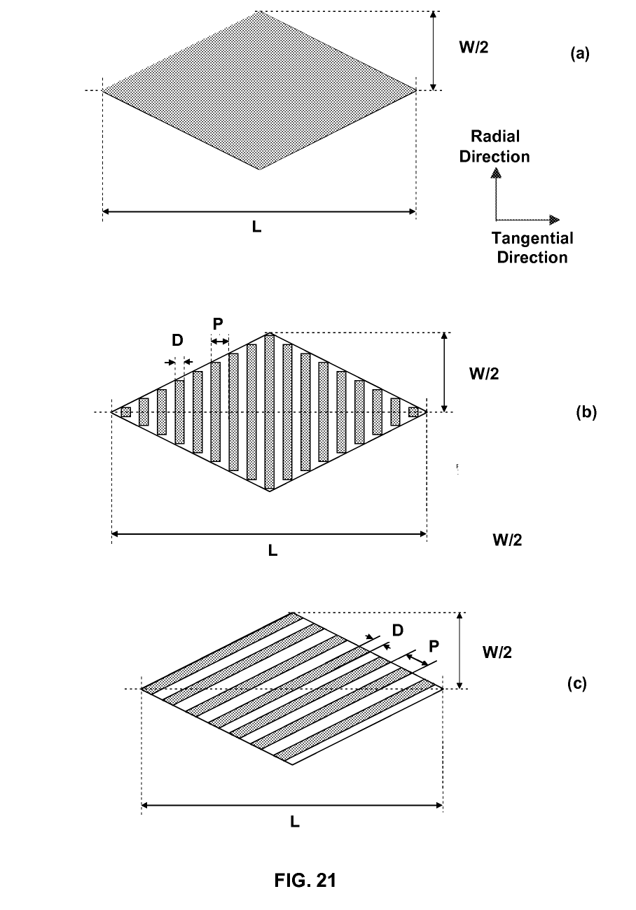

Two DVD-9 were coated with passive truncated diamond-shaped shutters, one in the open state and one in the closed state. The device stacks consisted of physical vapor deposited layers of ITO/WO3(Li)/Li/AlF4/ITO as shown by the photograph in FIG. 19. The radial extend of the truncated diamond covered a radius from approximately 22.6 mm through approximately 28.5 mm, with a maximum tangential extend of about 12 mm. In the closed shutter shown in FIG. 19, the WO3 was lithiated with sufficient charge to bleach the shutter for open state simulation. FIG. 20 shows the digital error rate (measured as errors per 8 error correction code (ECC) blocks of the channel code for a DVD) for Layer 1 for the closed shutter and the open shutter measure by a DVD CATS Tester manufactured by Audio Development (Malmo, Sweden). As a reference the error rate from a disc from the same batch as the open shutter is also shown. Even though, for this particular open shutter there exist some elevated errors in the focus and track servo signals, the resultant increase in digital error is still small and well within the specification limits for DVD of a maximum 280 errors per 8 ECC blocks. The error rate for the closed shutter, however, sharply increases as the disc is played back from the outer diameter towards the inner diameter on the Layer 1 information layer of the opposite track path disc. Playback was ceased at approximately a radius of 26.2 mm before reaching the maximum tangential extent of the closed shutter.

### Shape, Geometry and Location of EO Device

Due to differences in their optical properties, the transition from an area of the disc without an EC device to an area with an EC device may introduce variations that affect the ability of a reading or writing device or player to read from, or write to impacted areas of the disc. In cases where the EC device covers the entire disc and extends beyond the data structures, this “edge” does not affect the ability of the reading or writing device or player to read from, or write to the disc. It is often desirable, however, for the EC device to be smaller than the entire surface area of the disc. A smaller device lowers manufacturing costs (e.g. lower material costs, higher yields, and shorter production times), requires less power and switches states faster. Since it does not completely extend beyond the data structures, the edge of a smaller EC device may affect the ability of a reading device to read from, or writing device to write to the disc.

The EC device may have different geometries depending on the technology and placement region of data and reference files which need to be enabled or disabled by a manufacturer, vendor, user, etc. The EC device may be placed in a shape of an arc or another shape. The arc may also extend around the entire circumference or there may be more than one arc placed around the circumference or several radial patches. Each patch, may, for instance, be tuned for a particular wavelength of the readout beam, such as 650 nm and 405 nm for DVD, to prevent reading of the disc in the closed shutters state at both wavelengths. One may even cover the entire lead-in area, or the entire program area or both of these. The EC device may also be patterned in shapes such as stripes, cross lines, etc. The pattern may be in a form of diffraction grating which when colored will form a pattern akin to zones of different optical densities and diffract the laser beam. The pattern may be such that it covers selective data sectors or parts thereof so that critical information needed for the disc to function may be optionally disabled. One may also put a pattern such that the servo mechanism (e.g. for tracking or focusing onto an information track) loses lock subsequently rendering data retrieval impossible from a particular area of the information layer according to a required protocol. A patterned approach allows one to decrease the active area of the EC device. For an arc shape EC device intended for a DVD its active area should have a preferred arc length of about or greater than 7 mm, and its width be about greater than 0.5 mm. This may (active area) be a square in a size greater than about 7 mm×7 mm, or a rectangle with the tangential dimension being greater than about 7 mm and the other (radial dimension) preferably being greater than the tangential dimension. Smaller EC devices will require less power to switch, as the power requirements will typically be proportional to the active area. A preferred limit for the amount of power to switch the EC device is below 25 mW, and preferably below 5 mW. This is because the power is derived from the antenna when it is activated, which is limited. Thus preferred active area of EC device is less then 5 square cm, and preferably less than 2 square cm and most preferably less than 0.5 square cm. The switching time is also limited at check-out when the chip is activated. Thus the power application time for bleaching is less than 10 seconds, and preferably less than 5 seconds and most preferably less than 2 seconds. The EC device may fully bleach in this period, or may continue to self-bleach after the power application has stopped over the next several minutes to hours.

FIG. 21 shows another exemplary pattern for the EC device. The EC active area is shown as a diamond in FIGS. 21a-c. This could replace area 75 as shown in FIG. 7 or FIG. 8. The whole area within the diamond shape may be an EC device or it may be patterned as shown FIGS. 21b and 21c where only the darker areas are EC active and the areas between them are transparent and not switchable. As these will be powered with electronics with only a limited amount of power, it is best to minimize the EC active area. Preferably, the charge consumption for switching should be kept lower than IC, and more preferably lower than 100 mC and most preferably below 10 mC. Assuming that a typical EC device when powered between 1 to 5V may consume about 10 to 30 mC of charge per cm², it is best to have the active device area lower than 5 cm², and preferably lower than 2 cm² and most preferably lower than 0.5 cm². Keeping this in mind a diamond with width “W” equal to 0.6 cm and length “L” equal to 1.2 cm will have an area of 0.36 cm². Patterns in FIGS. 19b and 19c will reduce this area to half assuming the width of the EC areas (or stripes) to be equal to the width of the non-EC areas (or stripes). The width of the stripes “D” in FIGS. 21b and 21c should be preferably less than 1 mm, and more preferably less than 500 μm. The size is dependent not only upon the targeted readout configuration but also where the shutter is located relative to the information plane as will be discussed in further detail below. Some of the preferred widths of the EC regions are 15, 21, 27, 42, 228 and 456 microns. The width of the non-EC region plus the width of the non-EC regions “P” is preferably in the range of one to ten times “D.” The EC device may be placed in any orientation which may maximize the effectiveness of the dark (closed) state, however, it is preferred that the total width of the EC device cover 0.7 cm or more along a track to generate sufficient uncorrectable errors. One preferred orientation is for the short diamond axis in FIGS. 21b and 21C to orient along the radial direction of the disc and be located in the lead-in area and/or where the control data file (containing physical format information), the ISO/UDF file structure or any other enabling data is located. FIG. 21 only shows an example of a pattern formed by equally spaced linear stripes. The pattern may be formed by lines of unequal widths and spacing, may be in the form of a checker board, or the stripes may be curved with any desirable orientation. It will be appreciated that other patterns may be used. Further the boundary between the EC and the non-EC area may be sharp and well defined or it may be diffused.

Using the printing techniques one may also create watermarks and or codes (i.e., equivalent of pits and lands) which can be read by the machine in one state (say when the EC pattern is colored) and not in the other state (when the EC pattern is bleached). Preferably these patterns will have common electrodes, unless these need to be addressed selectively. This action is similar to writing and erasing information on a writable DVD discs where rather than actual pits one creates areas which have different refractive index and/or optical absorption. Thus these codes are present on the DVD as produced and limit the access to the data, however, these are bleached (or erased) when the DVD is legitimately activated. These codes or data encryption/authentication schemes could be the standard ones used in the industry such as “water marks” “content scrambling system (CSS)”, “content protection for prerecorded media (CPPM)”, “content protection for recordable media (CPRM)”, “copy generation management (CGMS)”, etc. or additional schemes. Further, there could be several protection schemes and levels of data access corresponding to activation of different patterns as required by the data owner. This may allow a user to purchase the same DVD for rent or ownership, where in the former, one of the codes is erased, and in the latter another or a second code is erased depending on the user intention and the price paid.

As described in above paragraphs, the EC device may have a geometry, size, pattern, orientation, and a location selected to cause the reading laser to lose tracking or focusing lock or distort the tightly focused reading spot. In such a way, the laser becomes ineffective in reading data or information from the disk, and renders the disk unusable in that reading device. In a similar manner, it disables the disc for any writing or rewriting purposes. By emphasizing the disturbance effects the EC device provides to the laser, the size of the EC device may thereby be reduced, while still disabling an unauthorized disc. Since the EC device is smaller, the amount of current required to activate or deactivate the EC layer is reduced. Additionally, the cost and complexity of manufacturing the disk may also be lowered.

In general terms, the geometry, pattern, orientation (particularly relative to the information tracks), size and location of the EC device or the EC materials within the device, may be designed and constructed to minimize or maximize various “effects” or disturbances that either individually or collectively minimize or maximize the reading or writing device's ability to read or write to the disc. These disturbances can further be combined with the coloring or bleaching properties of the EC device to create an effective, and a difficult to defeat, means for enabling or disabling access to data stored within the disc. In addition, optimizing the geometry, pattern, orientation, size and location of the EC materials within the EC device makes it possible to not only create effective means for enabling or disabling access to data stored within the disc, but also to reduce the amount of EC material required, thus reducing material cost, lower manufacturing yields and reduce the power and time required to switch the EC device's state.

For example, a disc may be provided with an EC device having an EC layer preset to make the disc unreadable. The EC layer may be coupled to an RF frequency module which is mounted or embedded on a disc. At a point of sale terminal, the disc is scanned with an RF enabled point of sale terminal, and a communication is established between the RF module and the POS terminal. The RF module may receive an activation code, and responsive to verifying the authenticity of the code, provide an electrical signal to clear the EC layer. To power the electrical signal, the RF module may have, for example, either 1) a very small battery or 2) a circuit for converting RF energy into an electrical signal. These small power sources must be sufficient to robustly and reliably switch the EC layer to make the disc readable only if the EC layer is comparatively small relative to the surface area of the disc.

The pattern, location, geometry, orientation, size and location of the EC device, or the EC material and associated materials in the EC stack within the EC device, can be used to minimize the edge effects to enable error free reading of, or writing to the disc. The pattern, location, geometry, orientation, size and location of the EC device, or the EC material and associated materials in the EC stack within the EC device can also be used to induce errors which cannot be corrected by the error correction capabilities of reading and writing devices and players by maximizing the edge and/or distortion effects and thus making the disc unusable without solely relying on blocking the laser light. This may result from distorting the focus of the readout beam or inducing spatial variation of phase, amplitude, and/or polarization onto the readout beam. The spatial frequency or frequencies of the EC material patterns may also be engineered to maximum effect by making it comparable to that of readout beam size at the point where the EC device is positioned vertically relative to the data structures in the disc.

The error correction code in a standard DVD for example, can enable a DVD player to recover from relatively long segments of unreadable data tracks (up to approximately 5 mm). It is not necessary to, for instance, completely block the interrogating read back beam over the entire segment, as long as sufficient errors are induced (to achieve uncorrectable errors) by altering the focused beam properties and quality or by inducing errors in the player servo systems to e.g. cause the beam to wander off track or defocus. It is therefore important to carefully select the optical properties of the EC device as well as the orientation and placement of the boundaries of the device layers for shutter which only covers a limited part of the accessible information stored on the optical disc. Conversely it is also possible to exploit the edge or boundary effects in a small EC device to introduce enough errors so that the reading device or player's error correction logic is not able to recover. Similar approaches can be taken for recordable or rewritable media to induce uncorrectable errors and make the disc unusable.

The EC device is designed, constructed, and placed to distort or disturb light reflected from the disc. With proper placement and orientation of the EC device, these distortions may be controlled to generate an expected level of induced errors in a disc reading system. This emphasis on induced error rate is a fundamental recognition that has enabled a new type of practical denial-of-benefit system. That is, the emphasis is not on how effectively the EC device blocks the optical properties of the disc itself, but now looks at the level of errors that a pattern can induce in a laser reading system. This shift enables the disc manufacturers, content providers, and distributors to practically implement a protected distribution system. For example, the EC device may have a pattern, geometry, shape, and location that effectively makes an unauthorized DVD unreadable in every or almost every consumer DVD player, and yet may be simply implemented at the point of sale in a retail environment. In this way, a disc is useless for consumer use until a retailer or approved distributor has authorized the disc.

Referring again to the example of a DVD disc for use in consumer DVD player. There are several mechanisms by which an EC device in a deactivated disc may induce sufficient errors in the reading process to render the disc unusable. For example, the EC device may distort the laser beam to induce a stream of non-correctable read errors. The distortion may be according to phase, amplitude, or polarization. The distortion effect may be adjusted or selected by the specific optical properties of the EC material or by the size, shape, or location of the EC device. For example, many EC materials have a profound effect on amplitude or transmission, while other electrically activated optical shutter materials, such as liquid crystals, have a more profound effect on phase and polarization.

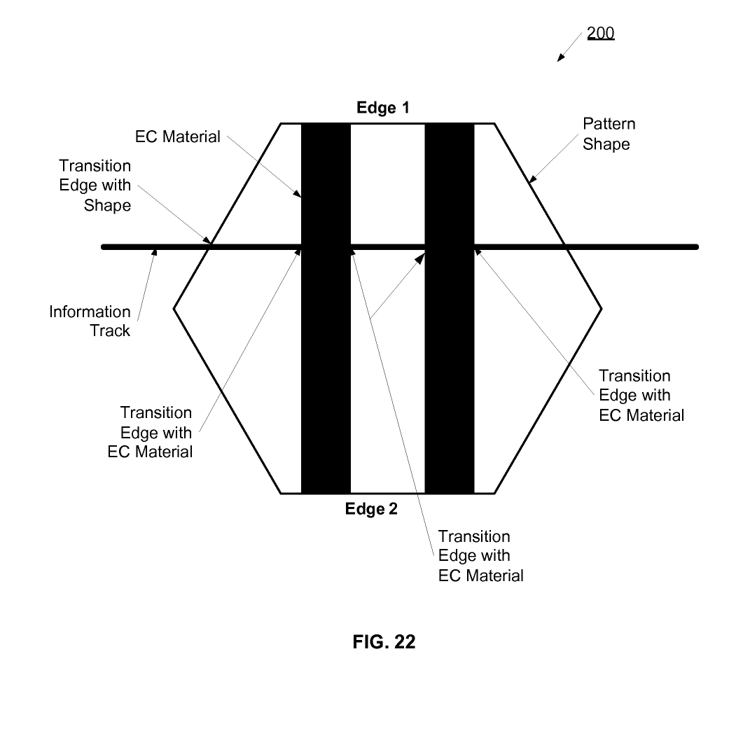

A disc may have one or more EC devices, and the EC devices may have different sizes, shapes, or characteristics depending on the particular application. In one application, the EC devices are distributed about the disc surface in a pattern or such that selective content can be blocked. In other applications, a single EC device may be sufficient. FIG. 22 shows an example of an EC device 150 in a colored or blocked state. The EC device 150 is shown having a six-sided shape, although it will be appreciated that other shapes may be used, such as circular, oval, arcing, radial, rectangular, or irregular. The EC device is a thin film device that uses a set of layers to selectably excite an EC layer. The EC layer is optically sensitive, and changes an optical property or properties when activated by an electrical signal. Although the property typically is its opaqueness, other optical properties may be changed. The EC material may fully cover the EC device, or the EC material may be arranged in a pattern independent of the electrodes (or counterelectrodes) further comprising the EC device. As illustrated, the EC material is in the shape of two parallel rectangles, and cover less than 50% of the EC device total area. Although the EC material is shown as parallel bars, it will be appreciated that many other shapes, designs, or patterns may be used.

One or more of the layers in the EC device may be transparent or nearly transparent. Therefore, even in areas where there is no EC material, other transparent or non-optically sensitive layers may be present. In use, the EC device is placed relative to an information track on an optical disc. As generally discussed earlier, when a disc is in an unauthorized state, the EC device may be designed and arranged to distort the reading laser so as to induce uncorrectable errors, thereby rendering the disc unusable. Certain transition edges may be managed to obtain desirable distortion effects and control. As shown above, the information track has a transition edge with the EC device shape, even when the EC layer does not extend to the shape's perimeter. Also, the information track has a transition edge with the actual EC material in the EC layer. When a pattern of EC material is used, as illustrated above, several transition edges are defined. Each of the transition edges has an impact on distortion, and, as will be more fully described below, the character and level of distortion may be controlled by adjusting the angle of the transition edge in relation to the information track.

Transition edges may be designed and constructed to produce desirable distortion effects. For example, a disc has a information track that generally spirals around from the center to the outside of the disc or vice versa. When an EC device is positioned relative to a particular segment of the information track, a transition edge is formed at the edge of the EC device, and if a patterned EC layer is employed, EC material transition edges are also formed. Depending on the orientations of the EC device and the EC material, different distortion effects may be affected.

The orientation and placement of transition edges may be used to control the level of generated distortion to the laser beam. For example, the edges indicated “Edge 1” and “Edge 2” in the FIG. 22 run predominantly parallel with the information track. These parallel edges are typically to be avoided if designing the transition geometry for minimum impact on tracking servo signals and therefore best readability in the open state of the EC shutter. Take the case where the open state optical characteristics of the shutter are too different from that of the no shutter state. In this design situation, the optical shutter edges should form a large angle with the information tracks. In case of a DVD the edges of the shutter can be completely perpendicular to the information tracks if the shutter covers an area fully extending across the information area in radial dimension, i.e., from radius approximately less than 22 mm to a radius as large as approximately 58 mm. However, with a minimum length along the track of 5 mm, the overall area is significantly larger than the desired area for reduced power requirements discussed above. Therefore, to further reduce the area of the shutter and at the same time keep the angles between the edges of the shutter as large as possible with respect to the information tracks one preferable shape of the shutter is diamond shaped as will be further detailed below. However, as the EC geometry/pattern affects both the open state playability and closed state non-playability, other designs may be alternatively applied to meet other design criteria. Take the case where an EC shutter design has open state optical characteristics that are virtually identical to that of the non shutter area, including edges which are largely parallel with the information tracks. This orientation will increase the amount of distortion for the closed state. These principles can be applied both to the general shape/geometry of the EC area as well as any patterns within the geometry. Another issue related to the transitional edge is the height of the various layers forming the EC device. These steps created by various layers may also lead to large focusing errors in the open state. One way of minimizing these are creating tapered edges or a series of smaller steps rather then single steps of each layer. The edges can be made into a tapered shape (or diffused) in PVD processes by controlling the mask distance from the substrate, or if printing is used by controlling surface tension between the substrate and the printing fluid to control contact angles or using dilute solutions around the edges.

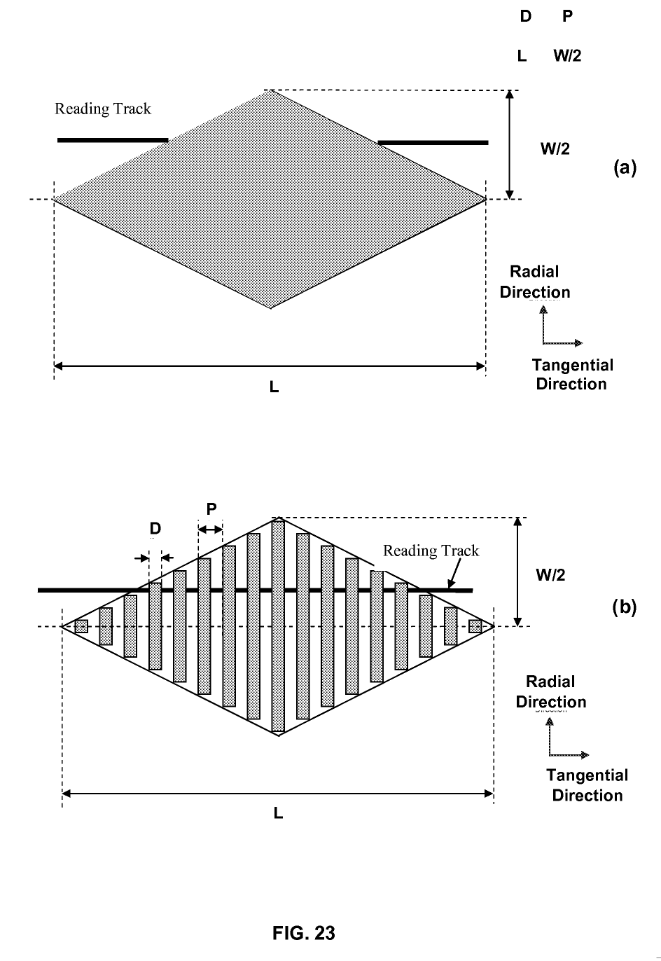

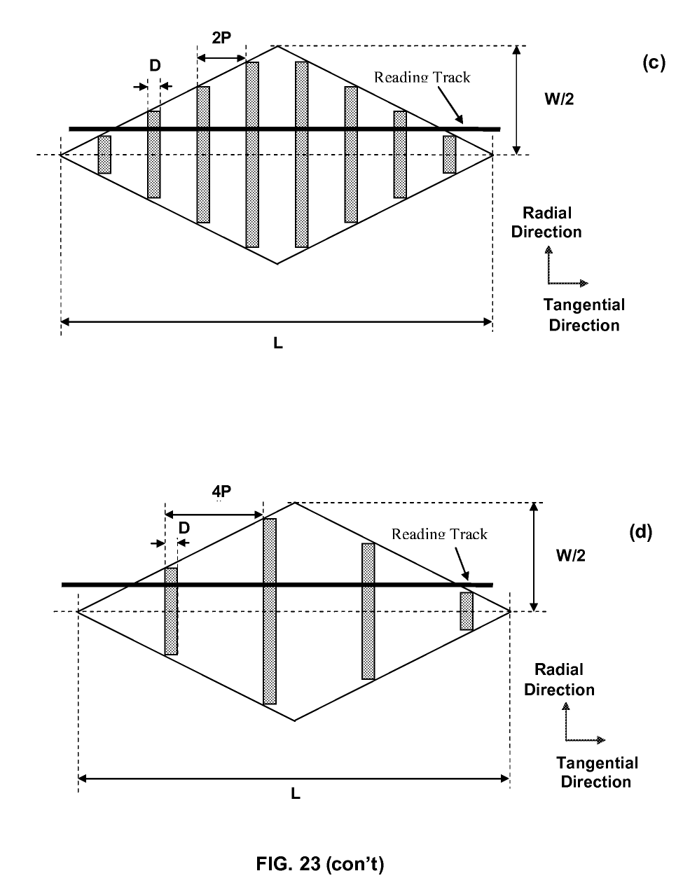

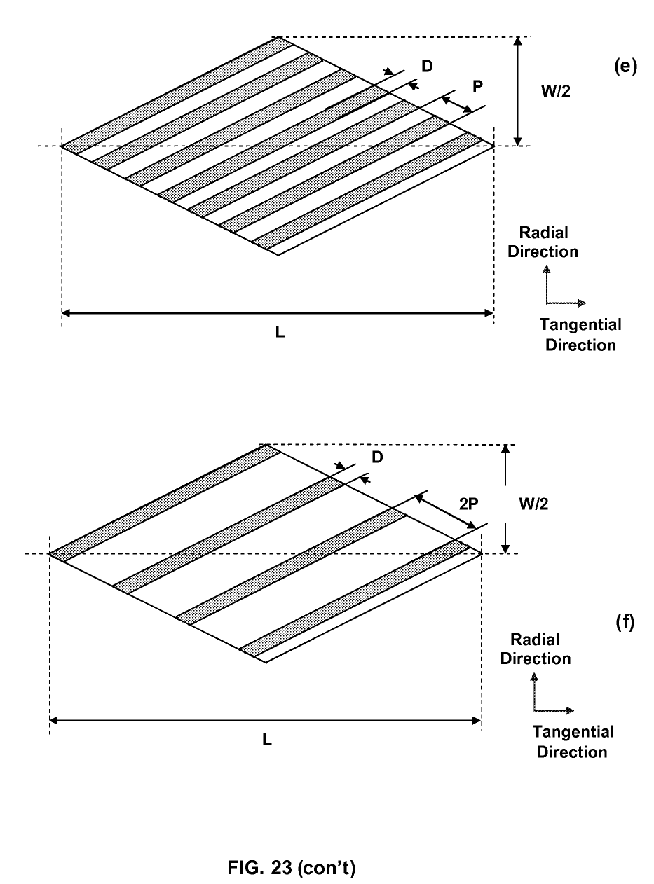

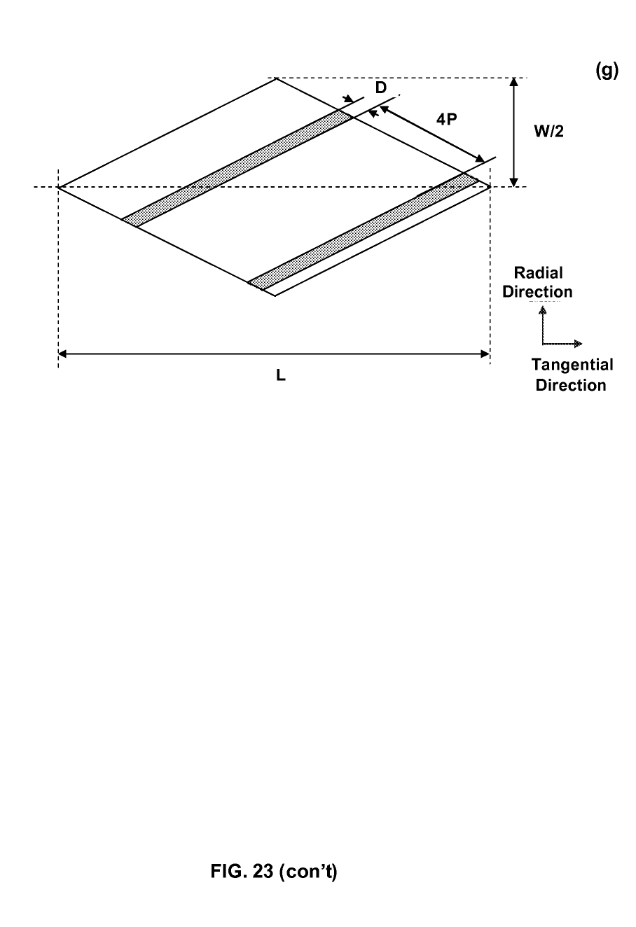

FIG. 23 illustrate a sampling of EC device and EC patterns that may be used on optical discs, such as a DVD. It will be appreciated that these patterns and methods may also be applied to other optical shutter technologies. and that the selection and details of any selected design are subject to the requirements of the particular application. For example, each design involves tradeoffs regarding security, cost, manufacturability, power available during activation, and the practicalities of distribution and sale. Although specific dimensions, shapes, and locations are discussed, these are not intended to be limiting, but are intended to illustrate the flexibility and wide applicability of a patterned EC layer and device.

FIG. 23(a) shows an EC device in the general shape of a diamond. The diamond EC pattern is positioned such that the information track makes a large angle at the transition to the EC device edge, the EC material, as well as edges of other associated materials in the EC stack. The EC material is solid within the diamond shape, so provides full blocking or distortion within the defined area. For example, the EC material may be selected to sufficiently block light from reading the data disk, or it may present an optical characteristic that distorts any reflected light. The distortion would be sufficient to induce at least one uncorrectable error in the DVD reading system, rendering the disc unusable. In this design, very substantial errors, resulting in at least one uncorrectable error will be induced when the EC material is blocked, and some errors may still be produced when the material is bleached. Also, this design is useful when the EC material itself has relatively low distortion effects, so when in a bleached state, the error level is acceptable resulting in no uncorrectable errors in the user data. In a more specific example, the EC layer may be selected with thickness or chemical properties that produce relatively low level of distortion.

Conditional access on DVD-9 may be affected by generating an EC stack pattern onto the L0 semi-reflective layer in order to block L1 access by the target player. In another arrangement, conditional access may be affected by generating an EC stack pattern onto the air incident side of L0 substrate in order to block both L0 and L1 access by the target player. Other applications and arrangements may be used. The dimensions for the device below may be according the following table:

| | | Target Dimensions |
|---|---|---|
| | Target Dimensions | (EC Stack onto |
| | (EC Stack onto L0 | Air Incident Side |
| | Semi-Reflective Layer) | of L0 Substrate): |
| W: | 6 mm | 6 mm |
| L: | 12 mm | 12 mm |

Total EC area: 36 mm2

FIG. 23(b) shows an EC device in the general shape of a diamond, which is filled with an EC material in a pattern. The diamond EC device has a device edge that has a large transition angle with the information track, minimizing any distortion effect, such as diffraction, in the radial dimension potentially causing tracking servo problems in the open shutter state. The EC pattern, though, is positioned such that the information track makes a generally orthogonal angle at the transition to the EC pattern material, fully minimizing any distortion effect in the radial dimension. The EC pattern material is generally arranged as a series of parallel bars, confined by the general diamond device edge. This arrangement allows less EC material to be used in contrast to the solid pattern in the above figure. For example, the device below may be constructed using only 18 mm2 of EC material, as compared to 36 mm2 for the device illustrated above. Also, since the information track has an orthogonal relationship with the long axis of the EC bars, less distortion may be generated when the EC material is bleached. It will also be appreciated that the individual bars may have different properties, which may further induce errors. However, as illustrated in the figure below, each of the bars is of a like EC material. The width and duty cycle (fill factor) of the bars depend on the size of the interrogating read beam at the position of the shutter in relation to the information layer in the direction substantially orthogonal to the information layer (and parallel to the propagation direction of the read out beam). In particular, the size of the beam depends primarily on the wavelength of the readout beam, the numerical aperture of the read out optic, and the distance between shutter and information layer. It should be noted that patterns can be preferably designed to affect the read out beam for several combinations of wavelengths and/or numerical apertures. The various feature sizes can be incorporated into one shutter or included in separate shutters or any combination thereof. This scheme can be particularly useful for assuring adequate blocking performance of a DVD shutter by also designing for shorter wavelengths operation, such as 405 nm, used by emerging higher density players (HD-DVD or Blu-ray Disc players). The EC materials must of course also be designed for multi-wavelength operation. For example, bars may be of smaller width when the EC layer is disposed within the disc and close to the information track as the cross-section of the converging cone of light from the readout device at which it intersects the EC device is relatively small. Generally, the width of the bars may be adjusted according to the size of the readout light as it passes through the EC device. Accordingly, the closer the EC layer is to the information layer to be blocked, the smaller the width of the bars may be designed to generate the desired level of distortion. As DVD players more or less require the same “cone” of light to read out the disc (same numerical aperture of the lens) this method/configuration has a similar effect on all players (using the same readout wavelength). Reducing the frequency of these bars in addition to reducing the overall active area may also adversely affect the servo performance of the player by interfering with focus, tracking, HF slicer, AGC (automatic gain control) circuitry, or other player functions. In this way, a smaller amount of EC material may be used to achieve sufficient levels of distortion to render a disc unusable. As servos are implemented differently by different player manufacturers it will be appreciated that the effect can be very player dependent.

The dimensions for the device below may be according the following table:

| | Target Dimensions | Target Dimensions |
|---|---|---|
| | (EC Stack onto L0 | (EC Stack onto Air Incident |
| | Semi-Reflective Layer) | Side of L0 Substrate): |
| W: | 6 mm | 6 mm |
| L: | 12 mm | 12 mm |
| D: | 21 μm, 15 μm, 27 μm, | 228 μm, 456 μm |
| | 42 μm, & 456 μm | |
| P: | 2 * D | 2 * D |

Total EC area: 18 mm2

FIG. 23(c) illustrates another EC device with a lower density of EC pattern material. The device edge and EC pattern are similar to the device and pattern described above, so will not be discussed in detail. This design may be applicable to a construction where even less EC material is employed. Depending on the EC material properties this design can induce similar errors at is the case above, but at half of the EC area. In this way, substantially less material is needed, and may be activated using far less power.

The dimensions for the device below may be according the following table:

| | Target Dimensions | Target Dimensions |
|---|---|---|
| | (EC Stack onto L0 | (EC Stack onto Air Incident |
| | Semi-Reflective Layer) | Side of L0 Substrate): |
| W: | 6 mm | 6 mm |
| L: | 12 mm | 12 mm |
| D: | 21 μm, 15 μm, 27 μm, | 228 μm, 456 μm |
| | 42 μm, & 456 μm | |
| P: | 2 * D | 2 * D |

Total EC area: 9 mm2

FIG. 23(d) illustrates another EC device with an even lower density of EC pattern material. The device edge and EC pattern is similar to the device and pattern described above, so will not be discussed in detail. This design may be applicable to a construction where even less EC material is employed. Depending on the EC material properties this design can induce similar errors at is the case above, but at half of the EC area. In this way, substantially less material is needed, and may be activated using far less power.

The dimensions for the device below may be according the following table:

| | Target Dimensions | Target Dimensions |
|---|---|---|
| | (EC Stack onto L0 | (EC Stack onto Air Incident |
| | Semi-Reflective Layer) | Side of L0 Substrate): |
| W: | 6 mm | 6 mm |
| L: | 12 mm | 12 mm |
| D: | 21 μm, 15 μm, 27 μm, | 228 μm, 456 μm |
| | 42 μm, & 456 μm | |
| P: | 2 * D | 2 * D |

Total EC area: 4.5 mm2

FIG. 23(e) shows an EC device in the general shape of a diamond. The EC device is filled with an EC material in a pattern. The EC material is generally arranged as a series of parallel bars, confined by a general diamond device edge. The parallel bars of the EC material have long edges that have a large transition angle with the information track thus inducing more distortion than an orthogonal edge transition. This arrangement allows less EC material to be used in contrast to a solidly filled EC device. For example, the device below may be constructed using only 18 mm2 of EC material, as compared to 36 mm2 for a solid pattern. Of course, as previously discussed, some level of distortion may also be generated when the EC material is bleached, and the level of distortion is likely to be greater than in the case where the EC material was orthogonal to the information track. Accordingly, the EC material and the target will have to limit the level of induced errors to a correctable level in the target device. It will also be appreciated that the individual bars may have different properties, which may further induce errors. However, as illustrate in the figure below, each of the bars is of a like EC material. The distance between bars may be selected according to several factors in a similar way as discussed above for the perpendicular bars. For example, bars may be spaced closer together when the EC layer is disposed within the disc and close to the information track. In this arrangement, additional bars may be needed to induce sufficient errors, as the bars are relatively close to the focus point of the laser. The dimensions for the device below may be according the following table:

| | Target Dimensions | Target Dimensions |
|---|---|---|
| | (EC Stack onto L0 | (EC Stack onto Air Incident |
| | Semi-Reflective Layer) | Side of L0 Substrate): |
| W: | 6 mm | 6 mm |
| L: | 12 mm | 12 mm |
| D: | 21 μm, 15 μm, 27 μm, | 228 μm, 456 μm |
| | 42 μm, & 456 μm | |
| P: | 2 * D | 2 * D |

Total EC area: 18 mm2

FIG. 23(f) illustrates another EC device with a lower density of EC pattern material. The device edge and EC pattern is similar to the device and pattern described above, so will not be discussed in detail. This design may be applicable to a construction where even less EC material is employed. Depending on the EC material properties this design can induce similar errors at is the case above, but at half of the EC FIG. 25 area. In this way, substantially less material is needed, and may be activated using far less power.

The dimensions for the device below may be according the following table:

| | Target Dimensions | Target Dimensions |
|---|---|---|
| | (EC Stack onto L0 | (EC Stack onto Air Incident |
| | Semi-Reflective Layer) | Side of L0 Substrate): |
| W: | 6 mm | 6 mm |
| L: | 12 mm | 12 mm |
| D: | 21 μm, 15 μm, 27 μm, | 228 μm, 456 μm |
| | 42 μm, & 456 μm | |
| P: | 2 * D | 2 * D |

Total EC area: 9 mm2

FIG. 23(g) illustrates another EC device with an even lower density of EC material. The EC device and pattern are similar to the device and pattern described above, so will not be discussed in detail. This design may be applicable to a construction where even less EC material is employed. Depending on the EC material properties this design can induce similar errors at is the case above, but at half of the EC area. In this way, substantially less material is needed, and may be activated using far less power. The dimensions for the device below may be according the following table:

| | Target Dimensions | Target Dimensions |
|---|---|---|
| | (EC Stack onto L0 | (EC Stack onto Air Incident |
| | Semi-Reflective Layer) | Side of L0 Substrate): |
| W: | 6 mm | 6 mm |
| L: | 12 mm | 12 mm |
| D: | 21 μm, 15 μm, 27 μm, | 228 μm, 456 μm |
| | 42 μm, & 456 μm | |
| P: | 2 * D | 2 * D |

Total EC area: 4.5 mm2

In FIG. 23, certain exemplary dimensions and sizes were given. The listed dimensions and sizes are for illustrative purposes only, and other sizes, shapes, dimensions, and relative dimensions may be used. For example, the EC Device was identified as being about 36 mm2, and the overall EC area as being in the range from 4.5 mm2 to 36 mm2. It will be appreciated that some applications may be enabled using smaller EC devices, and less overall EC area. It will be appreciated that the effect of the EC device may be advantageously applied to different areas of a typical DVD disc. For example, a typical DVD disc has an index and menu area that must be accessible for the disc to operate in the typical DVD player. In this way, it is not necessary to induce errors across the entire disc surface, but only in this limited index and menu area. Accordingly, a limited area of an EC pattern may effectively disable disc access in the typical consumer DVD player.

A disk may also be constructed with multiple patterns in one or multiple EC devices, with each pattern selected to induce errors in a somewhat different way. In this way, patterns may cooperate to generate an array of read errors that may further confound laser reading systems. Also, by combining such patterns, and overall smaller EC area may be used, which can be transitioned with less power. It will also be appreciated that as consumer's DVD players advance, different circuits and processes for reacting to the EC material and its associated transition line may be used. For example, future players may reduce their time to refocus, speed the time to re-establish tracking, or increase tolerance to distortion errors. Discs may therefore include EC devices and patterns for inducing uncorrectable errors for these expected advancements.

It should be noted that the foregoing embodiments are merely examples and are not to be construed as limiting the invention. The description of the embodiments is intended to be illustrative, and not to limit the scope of the claims. As such, the present teachings can be readily applied to other types of devices and many alternatives, modifications, and variations will be apparent to those skilled in the art

1. An optical media, comprising:
an RF antenna;
an electrochromic device positioned to interfere with a reading laser beam, the electrochromic device having a first optical state and a second optical state;
an integrated circuit connected to the electrochromic device and to the RF antenna;
the electrochromic device further comprising:
an electrolyte layer and an electrochromic layer having almost no potential across the device when the electrochromic layer is in the first optical state; and
the electrolyte layer and the electrochromic layer having almost no potential across the device when the electrochromic layer is in the second optical state.

2. The optical media according to claim 1, where there is less than about 0.3 volts potential across the device when the electrochromic device is in its first optical state.

3. The optical media according to claim 1, where there is less than about 0.3 volts potential across the device when the electrochromic device is in its second optical state.

4. The optical media according to claim 1, where there is about 0 volts potential across the device when the electrochromic device is in its first optical state.

5. The optical media according to claim 1, where there is about 0 volts potential across the device when the electrochromic device is in its second optical state.

6. The optical media according to claim 1, where:
the electrochromic layer is capable of being reduced, and changes from the first optical state to the second optical state upon reduction; and
the electrolyte layer comprises a material that is capable of being oxidized upon the application of a voltage to the device.

7. The optical media according to claim 1, where:
the electrochromic layer is capable of being oxidized, and changes the device from the first optical state to the second optical state upon oxidation; and
the electrolyte layer comprises a material that is capable of being reduced upon the application of a voltage to the electrochromic device.

8. The optical media according to claim 1, where the electrolyte layer comprises organic material.

9. The optical media according to claim 1, where the electrolyte layer comprises polymeric material.

10. The optical media according to claim 1, where the electrolyte layer comprises a polymeric salt.

11. The optical media according to claim 10, where the electrolyte layer comprises at least one of thiophene, furan, vanadyl sulfate or cobalt chloride.

12. The optical media according to claim 10, where the electrolyte layer comprises a redox material.

13. The optical media according to claim 1, where the electrolyte layer comprises a redox material.

14. The optical media according to claim 1, where the electrolyte layer comprises at least one of thiophene, furan, vanadyl sulfate or cobalt chloride.

15. The optical media according to claim 1, where the electrochromic layer comprises organic material.

16. The optical media according to claim 1, where the electrochromic layer comprises polyaniline.

17. The optical media according to claim 1, where the electrochromic layer comprises an acid.

18. The optical media according to claim 1, where the electrochromic layer comprises polyacrylic acid.

19. The optical media according to claim 1, where the electrolyte layer comprises an acid.

20. The optical media according to claim 1, where the electrolyte layer comprises polymeric acid.

21. The optical media according to claim 1, where the electrolyte layer and the electrochromic layer each comprise the same acid.

22. The optical media according to claim 1, where the electrolyte layer and the electrochromic layer each comprise polyacrylic acid.

23. The optical media according to claim 1, where the electrochromic layer comprises hydroquinone.

24. The optical media according to claim 1, where the electrolyte layer is between the electrochromic layer and a counterelectrode layer.

25. The optical media according to claim 24, where the electrolyte layer comprises inorganic material.

26. The optical media according to claim 24, where the electrolyte layer comprises LiAlF or LiPON.

27. The optical media according to claim 24, where the electrochromic layer comprises Li WO₃.

28. The optical media according to claim 1 or 24, where the electrochromic layer comprises metal.

29. The optical media according to claim 1 or 24, where the electrochromic layer comprises magnesium, aluminum, nickel, tungsten, tin, molybdenum, manganese, zinc, cobalt, chromium, or cobalt.

30. The optical media according to claim 1 or 24, where in the first optical state the electrochromic layer comprises a metal.

31. The optical media according to claim 1 or 24, where in the second optical state the electrochromic layer comprises an oxidized metal compound.

32. The optical media according to claim 24, wherein the counterelectrode layer comprises NiO, Ir₂O₃, CoO, or V₂O₅.

33. The optical media according to claim 1 or 24, wherein the electrochromic layer dissolves upon transitioning from the first optical state to the second optical state.

34. The optical media according to claim 1, wherein the electrochromic layer and the electrolyte layer connect to respective electrodes for receiving a power signal.

35. An optical media, comprising:
an RF antenna;
an electrochromic device positioned to interfere with a reading laser beam, the electrochromic device having a first optical state and a second optical state;
an integrated circuit connected to the electrochromic device and to the RF antenna;
the electrochromic device further comprising:
an electrochromic layer;
an electrolyte layer adjacent the electrochromic layer;
a material positioned to react with the electrochromic layer; and
wherein the material is in a first stable state when the device is in the first optical state and the material is in a second stable state when the device is in the second optical state.

36. The optical media according to claim 35, wherein the material is in the electrolyte layer.

37. The optical media according to claim 35, wherein the material is in the electrochromic layer.

38. The optical media according to claim 35, wherein the first stable state is a first stable oxidation state.

39. The optical media according to claim 35, wherein the second stable state is a second stable oxidation state.

40. The optical media according to claim 35, wherein:
the material in the first stable state is VOSO₄⁺²; and
the material in the second stable state is VOSO₄⁺³.

41. The optical media according to claim 35, where the electrolyte layer is between the electrochromic layer and a counter electrode layer.

42. The optical media according to claim 41, wherein the material is in the counter electrode layer.

43. The optical media according to claim 35, further comprising a first electrode connected to the electrochromic layer and a second electrode coupled to the electrolyte layer.

44. The optical media according to claim 43, wherein the device is arranged so that the layers are in the order of 1) the first electrode; 2) the electrochromic layer; 3) the electrolyte layer; and 4) the second electrode.

45. The optical media according to claim 35, further comprising:
the electrochromic device in the first optical state when a conductive shorting line shorts the device; and
wherein the electrochromic device takes more than about 8 hours at room temperature to transition from the first optical state to the second optical state.

46. The optical media according to claim 35, further comprising:
the electrochromic device in the first optical state when a conductive shorting line shorts the device; and
wherein the electrochromic device takes more than about 4 hours at about 50 degrees Celsius or greater to transition from the first optical state to the second optical state.

47. The optical media according to claim 35, further comprising:
the electrochromic device in the first optical state when a shorting line shorts the device; and
wherein the electrochromic device takes more than about 1 hour at about 80 degrees Celsius or greater to transition from the first optical state to the second optical state.

48. The optical media according to claim 35, wherein the first stable state is a substantially transparent optical state.

49. The optical media according to claim 35, wherein the first stable state is a substantially opaque optical state.

50. The optical media according to claim 35, wherein the second stable state is a substantially transparent optical state.

51. The optical media according to claim 35, wherein the second stable state is a substantially opaque optical state.

52. The optical media according to claim 35, wherein:
the material in the first stable state is a monomer; and the material in the second stable state is polymerized monomer.

53. The optical media according to claim 35, further comprising a first electrode connected to the electrochromic layer and a second electrode coupled to the electrolyte layer, and wherein one of electrodes comprises a portion of a metal data layer for the optical media.

54. A method of making an optical disc, comprising:
defining an optical shutter area for the optical disc;
placing an electrolyte layer in the optical shutter area;
placing an electrochromic layer in the optical shutter area and adjacent to the electrolyte layer;
providing a pair of electrodes, one electrode connected to the electrolyte layer and the other electrode connected to the electrochromic layer; and
connecting the electrodes to an integrated circuit.

55. The method according to claim 54, wherein the connecting step includes using a metal data layer of the disc for connecting to one of the electrodes.

56. The method according to claim 54, wherein the step of placing the electrochromic layer comprises depositing PANI.

57. The method according to claim 54, wherein the step of providing the pair of electrodes comprises depositing at least one of the electrodes as a transparent conducting material.

58. The method according to claim 54, wherein the defining step includes defining the optical shutter on a separate substrate piece, and further includes the step of attaching the separate substrate piece to the optical disc.

59. The method according to claim 54, wherein the defining step includes defining the optical shutter on a surface of the optical disc.

60. The method according to claim 54, wherein the electrolyte layer, the electrochromic layer, and the pair of electrodes form an electrochromic device.

61. The method according to claim 60, further including the step of adjusting the pH of the electrolyte material to change reversibility characteristics of the electrochromic device.

62. The method according to claim 60, further including the step of adding PSS acid to the electrolyte material to change reversibility characteristics of the electrochromic device.

63. The method according to claim 60, further including the step of adjusting the pH of the electrochromic material to change reversibility characteristics of the electrochromic device.

64. The method according to claim 60, further including the step of adding polyacrylic acid to the electrochromic material to change reversibility characteristics of the electrochromic device.

65. The method according to claim 54, further comprising the step of depositing a counter electrode layer adjacent the electrolyte layer.

66. The method according to claim 65, further including the step of adding a common material to each of the electrochromic material, the electrolyte material, and the counter electrode material to facilitate improved adhesion between respective layers.

67. The method according to claim 65, further including the step of doping the counter electrode material to change reversibility characteristics of the device.

68. The method according to claim 54, further including the step of doping the electrochromic material to change reversibility characteristics.

69. The method according to claim 54, further including the step of doping the electrolyte material to change reversibility characteristics.

70. The method according to claim 54, further including the step of adding a common material to both the electrochromic material and the electrolyte material to facilitate improved adhesion between the electrochromic layer and the electrolyte layer.

71. The method according to claim 54, further including the step of adding about 10% of a common material to both the electrochromic material and the electrolyte material to facilitate improved adhesion between the electrochromic layer and the electrolyte layer.

72. The method according to claim 54, further including the step of adding a polyacrylic acid to both the electrochromic material and the electrolyte material to facilitate improved adhesion between the electrochromic layer and the electrolyte layer.

73. The method according to claim 54, further including the step of adding a material to the electrochromic material to improve transmission characteristics at a target frequency.

74. The method according to claim 73, wherein the added material is hydro-quinone.

75. The method according to claim 73, wherein the target frequency is 405 nm.

76. The method according to claim 73, wherein the electrochromic layer comprises PANI, the material is hydro-quinone, and the target frequency is 405 nm.
